(19) United States
(12) Patent Application Publication
(10) Pub. No.: US 2026/0046940 A1
(43) Pub. Date: Feb. 12, 2026

(54) METHOD AND APPARATUS FOR TRANSMITTING CHANNEL INFORMATION BASED ON MACHINE LEARNING

(71) Applicants: Electronics and Telecommunications Research Institute, Daejeon (KR); KOOKMIN UNIVERSITY INDUSTRY ACADEMY COOPERATION FOUNDATION, Seoul (KR)

(72) Inventors: Sung-Hyun MOON, Daejeon (KR); Taehyung KIM, Seoul (KR)

(21) Appl. No.: 19/295,470

(22) Filed: Aug. 8, 2025

(30) Foreign Application Priority Data
Aug. 8, 2024 (KR) 10-2024-0106214
Oct. 2, 2024 (KR) 10-2024-0134319
Mar. 27, 2025 (KR) 10-2025-0039557
Mar. 28, 2025 (KR) 10-2025-0040446
Aug. 7, 2025 (KR) 10-2025-0109111

(51) Int. Cl. H04W 74/0833; H04L 5/14; H04W 72/23

(52) U.S. Cl. CPC H04W 74/0833; H04L 5/14; H04W 72/23

(57) ABSTRACT

A method of a terminal may comprise: receiving, from a base station, configuration information for a legacy random access channel (RACH) occasion (RO) and an additional RO; determining validity of an RO based on the configuration information; and performing a physical random access channel (PRACH) transmission in a valid RO, wherein the legacy RO is configured in a non-subband full-duplex (N-SBFD) resource, and the additional RO is configured in an SBFD resource.

### CROSS-REFERENCE TO RELATED APPLICATIONS

This application claims priority to Korean Patent Applications No. 10-2024-0106214, filed on Aug. 8, 2024, Korean Patent Applications No. 10-2024-0134319, filed on Oct. 2, 2024, Korean Patent Applications No. 10-2025-0039557, filed on Mar. 27, 2025, Korean Patent Applications No. 10-2025-0040446, filed on Mar. 28, 2025, and Korean Patent Applications No. 10-2025-0109111, filed on Aug. 7, 2025, with the Korean Intellectual Property Office (KIPO), the entire contents of which are hereby incorporated by reference.

### BACKGROUND

### 1. Technical Field

The present disclosure relates to a random access technique, and more particularly, to a random access technique in a communication system supporting subband full-duplex (SBFD).

### 2. Related Art

To accommodate the rapidly increasing mobile data traffic, a communication system (e.g., New Radio (NR) communication system) that uses frequency bands (e.g., frequency bands above 6 GHz) higher than frequency bands (e.g., frequency bands below 6 GHz) of a conventional communication system (e.g., Long Term Evolution (LTE) communication system) is being considered. The NR communication system can support not only frequency bands below 6 GHz but also frequency bands above 6 GHz, and can support various communication services and scenarios compared to the LTE communication system. For example, usage scenarios of the NR communication system include enhanced Mobile Broadband (eMBB), Ultra-Reliable Low Latency Communication (URLLC), and massive Machine Type Communication (mMTC). Communication technologies are required to satisfy the requirements of eMBB, URLLC, and mMTC.

Meanwhile, in a communication system (e.g., 5G NR system), a subband full-duplex (SBFD) operation that allows downlink communication and uplink communication simultaneously at the same time in a partial band among an entire system bandwidth may be supported for the purpose of improving cell throughput, reducing latency, enhancing reliability of transmitted and received signals, and/or increasing communication coverage. In the communication system supporting SBFD operation, an effective random access procedure and improvements for the random access procedure are required.

### SUMMARY

The present disclosure for resolving the above-described problems is directed to providing methods and apparatuses for random access in a communication system supporting subband full-duplex (SBFD).

A method of a terminal according to exemplary embodiments of the present disclosure may comprise: receiving, from a base station, configuration information for a legacy random access channel (RACH) occasion (RO) and an additional RO; determining validity of an RO based on the configuration information; and performing a physical random access channel (PRACH) transmission in a valid RO, wherein the legacy RO is configured in a non-subband full-duplex (N-SBFD) resource, and the additional RO is configured in an SBFD resource.

The configuration information may be applied to both the legacy RO and the additional RO, or the configuration information may include legacy RACH configuration information for configuring the legacy RO and additional RACH configuration information for configuring the additional RO.

The determining of validity of an RO based on the configuration information may comprise: determining a starting physical resource block (PRB) of the additional ROs by applying an offset included in the configuration information to a PRB having a lowest index within an uplink (UL) subband; and determining the additional RO as an invalid RO based on at least one PRB of the additional RO being located outside the UL subband, wherein the PRACH transmission is not performed in the invalid RO.

Indexing for the additional ROs may be performed independently of indexing for the legacy ROs.

The method may further comprise: receiving, from the base station, a physical downlink control channel (PDCCH) order including information indicating a UL cell or a supplementary uplink (SUL) cell in which the PRACH transmission is to be performed.

Based on the PDCCH order indicating that the PRACH transmission is to be performed in the SUL cell, the PRACH transmission may be performed in the legacy RO.

Based on the PDCCH order indicating that the PRACH transmission is to be performed in the UL cell, the PRACH transmission may be performed in an RO indicated by an RO indicator included in the PDCCH order among the legacy RO and the additional RO.

The method may further comprise: receiving, from the base station, a random access response (RAR) message in response to the PRACH transmission; determining a transmission power of a message 3 (Msg3) based on a power of the PRACH transmission; and transmitting the Msg3 to the base station using the determined transmission power.

The transmission power of the Msg3 may be determined based on an accumulated power ramp-up value from an initial PRACH transmission in the additional RO to a last PRACH transmission in the legacy RO.

The transmission power of the Msg3 may be determined based on an accumulated power ramp-up value from an initial PRACH transmission in the legacy RO to a last PRACH transmission in the additional RO.

A terminal according to exemplary embodiments of the present disclosure may comprise at least one processor, wherein the at least one processor may cause the terminal to perform: receiving, from a base station, configuration information for a legacy random access channel (RACH) occasion (RO) and an additional RO; determining validity of an RO based on the configuration information; and performing a physical random access channel (PRACH) transmission in a valid RO, wherein the legacy RO is configured in a non-subband full-duplex (N-SBFD) resource, and the additional RO is configured in an SBFD resource.

The configuration information may be applied to both the legacy RO and the additional RO, or the configuration information may include legacy RACH configuration information for configuring the legacy RO and additional RACH configuration information for configuring the additional RO.

In the determining of validity of an RO based on the configuration information, the at least one processor may cause the terminal to perform: determining a starting physical resource block (PRB) of the additional ROs by applying an offset included in the configuration information to a PRB having a lowest index within an uplink (UL) subband; and determining the additional RO as an invalid RO based on at least one PRB of the additional RO being located outside the UL subband, wherein the PRACH transmission is not performed in the invalid RO.

Indexing for the additional ROs may be performed independently of indexing for the legacy ROs.

The at least one processor may further cause the terminal to perform: receiving, from the base station, a physical downlink control channel (PDCCH) order including information indicating a UL cell or a supplementary uplink (SUL) cell in which the PRACH transmission is to be performed.

Based on the PDCCH order indicating that the PRACH transmission is to be performed in the SUL cell, the PRACH transmission may be performed in the legacy RO.

Based on the PDCCH order indicating that the PRACH transmission is to be performed in the UL cell, the PRACH transmission may be performed in an RO indicated by an RO indicator included in the PDCCH order among the legacy RO and the additional RO.

The at least one processor may further cause the terminal to perform: receiving, from the base station, a random access response (RAR) message in response to the PRACH transmission; determining a transmission power of a message 3 (Msg3) based on a power of the PRACH transmission; and transmitting the Msg3 to the base station using the determined transmission power.

The transmission power of the Msg3 may be determined based on an accumulated power ramp-up value from an initial PRACH transmission in the additional RO to a last PRACH transmission in the legacy RO.

The transmission power of the Msg3 may be determined based on an accumulated power ramp-up value from an initial PRACH transmission in the legacy RO to a last PRACH transmission in the additional RO.

According to the present disclosure, an SBFD terminal can perform a physical random access channel (PRACH) transmission in a legacy RO and/or an additional RO. The SBFD terminal can determine a valid RO by performing validity determination of the RO and may perform the PRACH transmission in the valid RO. The SBFD terminal can determine a transmission power of Msg3 by considering a PRACH transmission power and can transmit Msg3 by using the determined transmission power. Based on the above operation, a random access procedure can be efficiently performed in the communication system supporting SBFD, and performance of the communication system can be improved.

### BRIEF DESCRIPTION OF DRAWINGS

FIG. 1 is a conceptual diagram illustrating exemplary embodiments of a communication system.

FIG. 2 is a block diagram illustrating exemplary embodiments of an apparatus.

FIG. 3 is a conceptual diagram illustrating exemplary embodiments of SBFD configuration in a communication system.

FIG. 4 is a conceptual diagram illustrating exemplary embodiments of BWP configuration in a communication system supporting SBFD.

FIG. 5 is a conceptual diagram illustrating configuration of PRACH transmission occasions based on RACH configuration method #1 in a communication system supporting SBFD.

FIG. 6 is a conceptual diagram illustrating exemplary embodiments of PRACH transmission resources (e.g., PRACH transmission occasions) in a communication system supporting SBFD.

FIG. 7A and FIG. 7B are conceptual diagrams illustrating a PRACH transmission occasion indexing method and an SSB index mapping method in a communication system supporting SBFD.

FIG. 8 is a conceptual diagram illustrating a RACH configuration based on RACH configuration option 1.

FIG. 9 is a conceptual diagram illustrating a RACH configuration based on RACH configuration option 2.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the fifth generation (5G) communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system‘ or’NR communication system’.

In exemplary embodiments, ‘configuration of an operation (e.g., transmission operation)’ may mean ‘signaling of configuration information (e.g., information element(s), parameter(s)) for the operation’ and/or ‘signaling of information indicating performing of the operation’. In other words, ‘an operation (e.g., transmission operation) being configured in a communication node’ may mean that the communication node receives ‘configuration information (e.g., information element, parameter) for the operation’ and/or ‘information indicating to perform the operation’. ‘An information element (e.g., parameter) being configured in a communication node’ may mean that the information element is signaled to the communication node (e.g., the communication node receives the information element)’. Signaling may be at least one of system information (SI) signaling (e.g., transmission of a system information block (SIB) and/or master information block (MIB)), RRC signaling (e.g., transmission of RRC parameters and/or higher layer parameters), MAC control element (CE) signaling, or PHY signaling (e.g., transmission of downlink control information (DCI), uplink control information (UCI), and/or sidelink control information (SCI)). A message for SI signaling may be referred to as an SI message, a message for RRC signaling may be referred to as an RRC message, a message for MAC CE signaling may be referred to as a MAC message, and a message for PHY signaling may be referred to as a PHY message. The above-mentioned messages may be expressed as a first message, a second message, a third message, and so on.

In the present disclosure, an expression including “when ˜” may be expressed as an expression including “based on ˜” or an expression including “in response to ˜”. In other words, an expression including “when ˜” may be interpreted as being identical or similar to an expression including “based on ˜” or an expression including “in response to ˜”.

In the present disclosure, a ‘time’ may mean a time point, and ‘time’ and ‘time point’ may be used with the same meaning. A reception time of a signal or channel may mean a reception start time or a reception end time. A transmission time of a signal or channel may mean a transmission start time or a transmission end time.

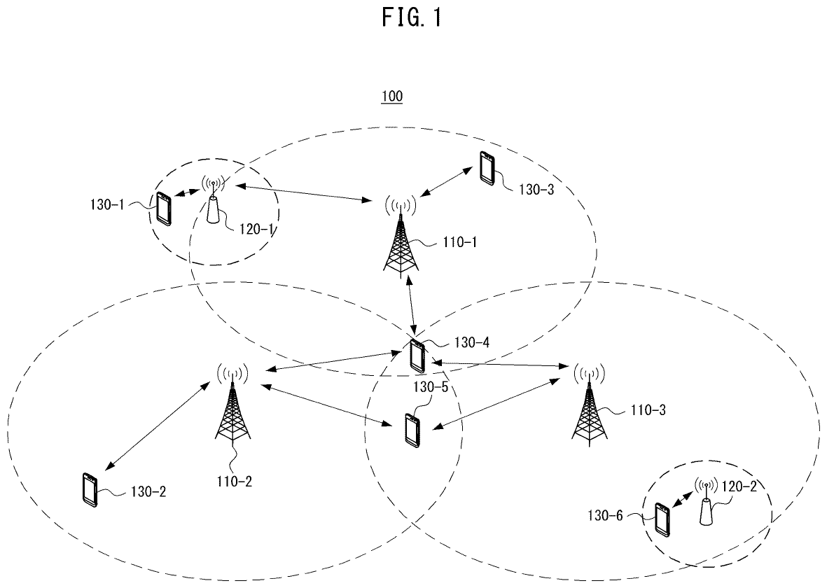

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g., a serving gateway (S-GW), a packet data network (PDN) gateway (P-GW), and a mobility management entity (MME)). When the communication system 100 is a 5G communication system (e.g., New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g., LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows.

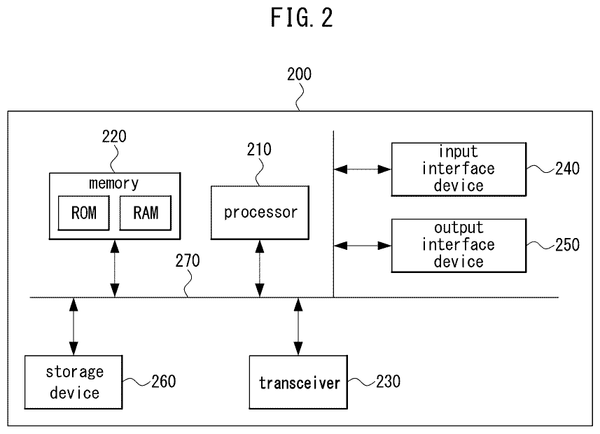

FIG. 2 is a block diagram illustrating exemplary embodiments of an apparatus.

Referring to FIG. 2, an apparatus 200 may comprise at least one processor 210, a memory 220, and a transceiver 230 connected to the network for performing communications. Also, the apparatus 200 may further comprise an input interface device 240, an output interface device 250, a storage device 260, and the like. The respective components included in the apparatus 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

The present disclosure relates to a signal transmission and reception method in a communication system. More specifically, random access procedures of communication nodes for enhancing transmission reliability, improving latency, and increasing communication coverage in a communication system supporting subband full-duplex (SBFD) operation are disclosed. The following exemplary embodiments may be applied not only to an NR communication system but also to other communication systems (e.g., LTE communication system, 5G communication system, 6G communication system, and the like).

The NR communication system can support a system bandwidth (e.g., a carrier bandwidth) wider than a system bandwidth provided by the LTE communication system in order to efficiently use a wide frequency band. For example, the maximum system bandwidth supported by the LTE communication system may be 20 MHz. In contrast, the NR communication system can support a carrier bandwidth of up to 100 MHz in a frequency band below 6 GHz, and a carrier bandwidth of up to 400 MHz in a frequency band above 6 GHz.

A numerology applied to physical signals and channels in the communication system (e.g., NR communication system or 6G communication system) may be variable. The numerology may vary to satisfy various technical requirements of the communication system. In the communication system to which a cyclic prefix (CP) based OFDM waveform technology is applied, the numerology may include a subcarrier spacing and a CP length (or CP type). Table 1 below may be a first exemplary embodiment of configuration of numerologies for the CP-based OFDM. The subcarrier spacings may have an exponential multiplication relationship of 2, and the CP length may be scaled at the same ratio as the OFDM symbol length. Depending on a frequency band in which the communication system operates, at least some numerologies among the numerologies of Table 1 may be supported. In addition, in the communication system, numerologies not listed in Table 1 may be further supported. CP type(s) not listed in Table 1 (e.g., extended CP) may be additionally supported for a specific subcarrier spacing (e.g., 60 kHz).

Table 1 relates to a first exemplary embodiment of a method for configuring numerologies for a CP-OFDM based communication system.

TABLE 1

| | Subcarrier spacing | | | | | |
|---|---|---|---|---|---|---|
| | 15 | 30 | 60 | 120 | 240 | 480 |
| | kHz | kHz | kHz | kHz | kHz | kHz |
| OFDM symbol | 66.7 | 33.3 | 6.7 | 8.3 | 4.2 | 2.1 |
| length [μs] | | | | | | |
| CP length [μs] | 4.76 | 2.38 | 1.19 | 0.60 | 0.30 | 0.15 |
| Number of | 14 | 28 | 56 | 112 | 224 | 448 |
| OFDM symbols | | | | | | |
| within 1 ms | | | | | | |

In the following description, a frame structure in the communication system will be described. In the time domain, elements constituting a frame structure may include a subframe, slot, mini-slot, symbol, and the like. The subframe may be used as a unit for transmission, measurement, and the like, and the length of the subframe may have a fixed value (e.g., 1 ms) regardless of a subcarrier spacing. A slot may comprise consecutive symbols (e.g., 14 OFDM symbols). The length of the slot may be variable differently from the length of the subframe. For example, the length of the slot may be inversely proportional to the subcarrier spacing.

A slot may be used as a unit for transmission, measurement, scheduling, resource configuration, timing (e.g., scheduling timing, hybrid automatic repeat request (HARQ) timing, channel state information (CSI) measurement and reporting timing, etc.), and the like. The length of an actual time resource used for transmission, measurement, scheduling, resource configuration, etc. may not match the length of a slot. A mini-slot may include consecutive symbol(s), and the length of a mini-slot may be shorter than the length of a slot. A mini-slot may be used as a unit for transmission, measurement, scheduling, resource configuration, timing, and the like. A mini-slot (e.g., the length of a mini-slot, a mini-slot boundary, etc.) may be predefined in the technical specifications. Alternatively, a mini-slot (e.g., the length of a mini-slot, a mini-slot boundary, etc.) may be configured (or indicated) to the terminal. When a specific condition is satisfied, use of a mini-slot may be configured (or indicated) to the terminal.

The base station may schedule a data channel (e.g., physical downlink shared channel (PDSCH), physical uplink shared channel (PUSCH), physical sidelink shared channel (PSSCH)) using some or all of symbols constituting a slot. In particular, for URLLC transmission, unlicensed band transmission, transmission in a situation where an NR communication system and an LTE communication system coexist, and multi-user scheduling based on analog beamforming, a data channel may be transmitted using a portion of a slot. In addition, the base station may schedule a data channel using a plurality of slots. In addition, the base station may schedule a data channel using at least one mini-slot.

In the frequency domain, elements constituting the frame structure may include a resource block (RB), subcarrier, and the like. One RB may include consecutive subcarriers (e.g., 12 subcarriers). The number of subcarriers constituting one RB may be constant regardless of a numerology. In this case, a bandwidth occupied by one RB may be proportional to a subcarrier spacing of a numerology. An RB may be used as a transmission and resource allocation unit for a data channel, control channel, and the like. Resource allocation of a data channel may be performed in units of RBs or RB groups (e.g., resource block group (RBG)). One RBG may include one or more consecutive RBs. Resource allocation of a control channel may be performed in units of control channel elements (CCEs). One CCE may include one or more RBs in the frequency domain.

In the communication system (e.g., NR communication system), the above-described unit time resource (hereinafter, ‘slot’) may be composed of a combination of one or more of downlink (DL) period, flexible (FL) period (or unknown period), and an uplink (UL) period. Each of a DL period, FL period, and UL period may be comprised of one or more consecutive symbols. An FL period may be located between a DL period and a UL period, between a first DL period and a second DL period, or between a first UL period and a second UL period. When an FL period is inserted between a DL period and a UL period, the FL period may be used as a guard period.

A slot may include one or more FL periods. Alternatively, a slot may not include an FL period. The terminal may perform a predefined operation in an FL period. Alternatively, the terminal may perform an operation configured by the base station semi-statically or periodically in an FL period. For example, the periodic operation configured by the base station may include a PDCCH monitoring operation, synchronization signal/physical broadcast channel (SS/PBCH) block reception and measurement operation, channel state information-reference signal (CSI-RS) reception and measurement operation, downlink semi-persistent scheduling (SPS) PDSCH reception operation, sounding reference signal (SRS) transmission operation, physical random access channel (PRACH) transmission operation, periodically-configured PUCCH transmission operation, PUSCH transmission operation according to a configured grant, and the like. An FL symbol may be overridden by a DL symbol or a UL symbol. When an FL symbol is overridden by a DL symbol or a UL symbol, the terminal may perform a new operation instead of the existing operation in the corresponding FL symbol (e.g., overridden FL symbol).

A slot format may be configured semi-statically by higher layer signaling (e.g., radio resource control (RRC) signaling). Information indicating a semi-static slot format may be included in system information, and the semi-static slot format may be configured in a cell-specific manner. In addition, a semi-static slot format may be additionally configured for each terminal through terminal-specific higher layer signaling (e.g., RRC signaling). An FL symbol of a slot format configured cell-specifically may be overridden by a DL symbol or a UL symbol by terminal-specific higher layer signaling. In addition, a slot format may be dynamically indicated by physical layer signaling (e.g., slot format indicator (SFI) included in downlink control information (DCI)). The semi-statically configured slot format may be overridden by a dynamically indicated slot format. For example, a semi-static FL symbol may be overridden by a DL symbol or a UL symbol according to the SFI.

The terminal may perform DL operations, UL operations, and sidelink operations in a bandwidth part. A bandwidth part may be defined as a set of consecutive RBs (e.g., physical resource blocks (PRBs)) having a specific numerology in the frequency domain. One numerology may be used for transmission of signals (e.g., transmission of control channel or data channel) in one bandwidth part. In the present disclosure, when used in a broad sense, a ‘signal’ may refer to any physical signal and channel. A terminal performing an initial access procedure may obtain configuration information of an initial bandwidth part from the base station through system information. A terminal operating in an RRC connected state may obtain the configuration information of the bandwidth part from the base station through terminal-specific higher layer signaling.

The configuration information of the bandwidth part may include a numerology (e.g., subcarrier spacing and/or cyclic prefix (CP) length) applied to the bandwidth part. The configuration information of the bandwidth part may further include information indicating a location of a starting RB (e.g., a starting PRB) of the bandwidth part and information indicating the number of RBs (e.g., PRBs) constituting the bandwidth part. At least one bandwidth part among the bandwidth part(s) configured in the terminal may be activated. For example, within one carrier, one UL bandwidth part and one DL bandwidth part may be activated respectively. In a time division duplex (TDD) based communication system, a pair of a UL bandwidth part and a DL bandwidth part may be activated. The base station may configure a plurality of bandwidth parts to the terminal within one carrier, and may switch the active bandwidth part of the terminal.

### [Random Access Procedure]

Prior to initiation of a physical random access procedure, Layer 1 (L1) may receive a set of SS/PBCH block indexes from higher layers and may provide a set of RSRP measurement values to the higher layers.

Prior to initiation of the physical random access procedure, Layer 1 may receive the following information from the higher layers.
Configuration of physical radio access channel (PRACH) transmission parameters (e.g., PRACH preamble format, time resources, and/or frequency resources for PRACH transmission)
Parameters for determining root sequences within a PRACH preamble sequence set and cyclic shifts of the root sequences (e.g., an index for a logical root sequence table, a cyclic shift N_{CS}, and a set type (e.g., unrestricted, restricted set A, or restricted set B))

From a physical layer perspective, an L1 random access procedure may include transmission of a random access preamble (Msg1) on PRACH, transmission of a random access response (RAR) message (Msg2) through PDCCH/PDSCH, transmission of a PUSCH (Msg3) scheduled by an RAR UL grant, and transmission of a PDSCH (Msg4) for contention resolution.

When a random access procedure is initiated by a PDCCH order for a terminal, a PRACH transmission may have the same subcarrier spacing (SCS) as a PRACH transmission initiated by the higher layers.

When two UL carriers are configured for a terminal with respect to a serving cell and the terminal detects a PDCCH order, the terminal may determine a UL carrier for PRACH transmission by using a value of a UL/supplementary uplink (SUL) indicator field included in the detected PDCCH order.

### [Method for Transmission of a Random Access Preamble]

A physical random access procedure may be triggered by a PRACH transmission request by higher layers or by a PDCCH order. A configuration by the higher layers for PRACH transmission may include the following.
Configuration for PRACH transmission
Preamble index, preamble SCS, P_{PRACH,target}, RA-RNTI, and PRACH resource PRACH may be transmitted in an indicated PRACH resource with a transmission power (e.g., P_{PRACH,b,f,c}(i)) by using a selected PRACH format.

A number N of SS/PBCH blocks associated with one PRACH occasion and a number R of contention-based preambles per SS/PBCH block per valid PRACH occasion may be provided to the terminal through ssb-perRACH-OccasionAndCB-PreamblesPerSSB. Each of N and R may be a rational number and/or a natural number. When N is smaller than 1, one SS/PBCH block may be mapped to 1/N consecutive valid PRACH occasions, and R contention-based preambles associated with an SS/PBCH block per valid PRACH occasion having consecutive indexes may start from a preamble index 0. When N is equal to or greater than 1, R contention-based preambles having consecutive indexes associated with an SS/PBCH block n per valid PRACH occasion may start from a preamble index

$$n \cdot {N}_{p r e a m b l e}^{total} / N .$$

n may be equal to or greater than 0, and n may be equal to or smaller than N−1.

$${N}_{p r e a mble}^{total}$$

may be indicated by totalNumberOfRA-Preambles and may be an integer multiple of N.

For link recovery, N SS/PBCH blocks associated with one PRACH occasion may be provided to the terminal by ssb-perRACH-Occasion in BeamFailureRecoveryConfig. For a dedicated RACH configuration provided by RACH-ConfigDedicated, when cfra is provided, N SS/PBCH blocks associated with one PRACH occasion may be provided to the terminal by ssb-perRACH-Occasion in occasions. When N is smaller than 1, one SS/PBCH block may be mapped to 1/N consecutive valid PRACH occasions. When N is equal to or greater than 1, every consecutive N SS/PBCH blocks may be associated with one PRACH occasion.

SS/PBCH block indexes provided by ssb-PositionsInBurst in a system information block 1 (SIB1) or ServingCellConfigCommon may be mapped to valid PRACH occasions in the following order according to parameters specified in the technical specifications.
First, an increasing order of preamble indexes within a single PRACH occasion
Second, an increasing order of frequency resource indexes for PRACH occasions multiplexed in the frequency domain
Third, an increasing order of time resource indexes for PRACH occasions multiplexed in the time domain within a PRACH slot
Fourth, an increasing order of indexes for PRACH slots

An association period for mapping SS/PBCH blocks to PRACH occasions starting from a frame 0 may be the smallest value from a set determined by a PRACH configuration period specified in the technical specifications. The smallest value may be a value such that N_{Tx}^{SSB} SS/PBCH blocks are mapped at least once to PRACH occasions within the association period. The terminal may acquire

$${N}_{Tx}^{SSB}$$

from a value of ssb-PositionsInBurst in SIB1 or ServingCellConfigCommon. When there is a set of PRACH occasions or PRACH preambles that are not mapped to

$${N}_{Tx}^{SSB}$$

SS/PBCH blocks after integer cycles of mapping from SS/PBCH blocks to PRACH occasions within the association period, no SS/PBCH blocks may be mapped to the set of PRACH occasions or PRACH preambles. An association pattern period may include one or more association periods, and a pattern between PRACH occasions and SS/PBCH blocks may be determined to repeat every 160 msec at maximum. When PRACH occasions not associated with SS/PBCH blocks exist after integer association periods, the PRACH occasions may not be used for PRACH transmissions.

For a PRACH transmission triggered by a PDCCH order, when a value of a random access preamble index field is not 0, a PRACH mask index field may indicate a PRACH occasion for PRACH transmission. The PRACH occasions may be associated with an SS/PBCH block index indicated by an SS/PBCH block index field of the PDCCH order.

For a PRACH transmission triggered by the higher layers, when ssb-ResourceList is provided, a PRACH mask index may be indicated by ra-ssb-OccasionMaskIndex. ra-ssb-OccasionMaskIndex may indicate PRACH occasions for PRACH transmission. The PRACH occasions may be associated with a selected SS/PBCH block index.

PRACH occasions may be consecutively mapped per SS/PBCH block index. Indexing of PRACH occasions indicated by a mask index value may be reset for each mapping cycle of consecutive PRACH occasions per SS/PBCH block index. The terminal may select a PRACH occasion indicated by the PRACH mask index value for an indicated SS/PBCH block index in the first available mapping cycle for PRACH transmission.

For the indicated preamble index, an order of PRACH occasions may be as follows.
First, an increasing order of frequency resource indexes for PRACH occasions multiplexed in the frequency domain
Second, an increasing order of time resource indexes for PRACH occasions multiplexed in the time domain within a PRACH slot
Third, an increasing order of indexes for PRACH slots For a PRACH transmission triggered by a request from the higher layers, when csirs-ResourceList is provided, a value of ra-OccasionList may indicate a list of PRACH occasions for PRACH transmission. The PRACH occasions may be associated with a selected CSI-RS index indicated by csi-RS. Indexing of PRACH occasions indicated by ra-OccasionList may be reset for each association pattern period.

TABLE 2

| PRACH configuration | Association period |
|---|---|
| period (msec) | (Number of PRACH configuration periods) |
| 10 | {1, 2, 4, 8, 16} |
| 20 | {1, 2, 4, 8} |
| 40 | {1, 2, 4} |
| 80 | {1, 2} |
| 160 | {1} |

For a paired spectrum or a supplementary uplink band, all PRACH occasions may be valid. For an unpaired spectrum, when tdd-UL-DL-ConfigurationCommon is not provided to the terminal, a PRACH occasion may not precede an SS/PBCH block within a PRACH slot. When the PRACH occasion starts after at least N_{gap} symbols from the last SS/PBCH block symbol, the PRACH occasion may be valid. N_{gap} may be defined in the technical specifications.

When tdd-UL-DL-ConfigurationCommon is provided to the terminal, a PRACH occasion within a PRACH slot may be valid in the following cases.
When the PRACH occasion is within UL symbols, or
When the PRACH occasion does not precede an SS/PBCH block within the PRACH slot, the PRACH occasion starts after at least N_{gap} symbols from the last DL symbol, and the PRACH occasion starts after at least N_{gap} symbols from the last SS/PBCH block symbol.

For a preamble format B4, N_{gap} may be 0.

TABLE 3

| preamble SCS | N_{gap} |
|---|---|
| 1.25 kHz or 5 kHz | 0 |
| 15 kHz, 30 kHz, 60 kHz, or 120 kHz | 2 |

In the case that a random access procedure is initiated by a PDCCH order, the terminal may transmit a PRACH in a selected PRACH occasion as defined in the technical specifications when a random access procedure is requested by the higher layers. A time between the last symbol of reception of the PDCCH order and the first symbol of the PRACH transmission may be equal to or greater than (N_{T,2}+Δ_{BWPSwitching}+O_{Delay}) msec. N_{T,2} may correspond to a time duration of N₂ symbols corresponding to a PUSCH preparation time for a processing capability 1 of the terminal assuming μ corresponding to the smallest SCS configuration between an SCS configuration of the PDCCH order and an SCS configuration of the PRACH transmission corresponding to the PDCCH order. When an active UL BWP is not changed, Δ_{BWPSwitching} may be 0. When the active UL BWP is changed, Δ_{BWPSwitching} may be defined in the technical specifications. For FR1, Δ_{Delay} may be 0.5 msec. For FR2, Δ_{Delay} may be 0.25 msec. For a PRACH transmission using 1.25 kHz SCS or 5 kHz SCS, the terminal may determine N₂ by assuming an SCS configuration μ=0.

For a single cell operation or an operation based on carrier aggregation in the same frequency band, the terminal may not transmit PRACH and PUSCH/PUCCH/SRS in the same slot. When a gap between each of the first symbol or the last symbol of a PRACH transmission in the first slot and the last symbol or the first symbol of a PUSCH/PUCCH/SRS transmission in the second slot is smaller than N symbols, the terminal may not transmit PRACH. For μ=0 or μ=1, N may be 2. For μ=2 or μ=3, N may be 4. μ may be an SCS configuration for the active UL BWP.

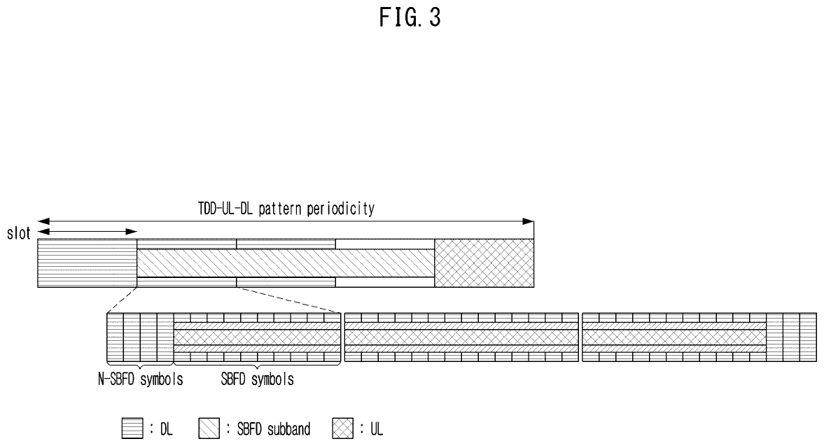

FIG. 3 is a conceptual diagram illustrating exemplary embodiments of SBFD configuration in a communication system.

Referring to FIG. 3, a partial region of a system bandwidth may be configured as a DL subband and a UL subband for SBFD. A base station may transmit configuration information on UL/DL subbands related to SBFD to a terminal through higher layer signaling (e.g., SIB, RRC message, etc.). The terminal may receive the configuration information on the UL/DL subbands related to SBFD from the base station. The terminal may perform transmission and reception operations based on the UL/DL subband configuration information.

The UL/DL subbands may be configured for SBFD operations. In the present disclosure, the UL/DL subbands may be interpreted as a UL subband and/or a DL subband. The UL/DL subbands may be configured in a carrier operating based on TDD. The UL/DL subbands may be configured in DL slots/symbols and/or FL slots/symbols among TDD slots/symbols. In the present disclosure, slots/symbols may be interpreted as slots and/or symbols. One slot may be configured with Orthogonal Frequency Division Multiplexing (OFDM) symbols in which UL/DL subbands are configured (hereinafter referred to as ‘SBFD symbols’) and/or symbols in which UL/DL subbands are not configured (hereinafter referred to as ‘non (N)-SBFD symbols’).

A time domain pattern and a period for SBFD symbols (e.g., SBFD resources) may be configured for the terminal through signaling of the base station. For example, a specific SBFD symbol pattern may be consecutively configured within a TDD UL/DL pattern and period configured by higher layers (e.g., TDD-UL-DL-Config, TDD-UL-DL-ConfigCommon, etc.). An SBFD symbol pattern may periodically occur repeatedly. A period of the SBFD symbol pattern may be equal to a TDD UL/DL pattern period.

A frequency location corresponding to UL/DL subbands within SBFD symbols may be explicitly configured for the terminal through higher layer signaling. For example, a frequency location and/or a size of bandwidth of a UL subband and a frequency location and/or a size of bandwidth of a DL subband may be configured for the terminal through signaling of the base station. A guard band may exist between the UL subband and the DL subband, and the guard band may correspond to a band not configured as the UL subband or the DL subband. A frequency location of the UL/DL subbands may be independently configured for each subcarrier spacing.

Configuration of UL/DL subbands for SBFD operations may be configured through cell-specific signaling (e.g., SIB or cell-common RRC message) or UE-specific signaling (e.g., UE-specific RRC message). When UL/DL subband configuration for SBFD is provided to the terminal through cell-specific signaling, a subcarrier spacing (SCS) of the UL/DL subbands may be configured for the terminal through cell-specific signaling. The SCS of the UL/DL subbands may follow an SCS configuration value present within a TDD configuration configured as cell-common. For example, the SCS configuration value may be a value configured by referenceSubcarrierSpacing in TDD-UL-DL-ConfigCommon.

Meanwhile, in a communication system (e.g., 5G communication system or NR communication system), in order to improve cell throughput, reduce latency, and reduce power consumption of terminals, a BWP to be actually used for transmission and reception among an entire system bandwidth may be configured. The base station may configure one or more BWPs for UL communication and DL communication for the terminal, may activate one BWP among the one or more BWPs, and may perform communication using the active BWP. The terminal may receive configuration of the one or more BWPs from the base station, and may perform communication with the base station using one active BWP among the one or more BWPs.

The terminal may receive a BWP configuration through signaling of the base station. The BWP configuration may include configuration information on DL BWP(s) and/or UL BWP(s). For example, the terminal may receive configuration of the following parameters from the base station.
Subcarrier spacing (subcarrierSpacing)
Cyclic prefix length (cyclicPrefix)
Frequency location and bandwidth of each BWP (locationAndBandwidth)
ID of each BWP (BWP-Id)

In a TDD band, a DL BWP and a UL BWP configured with the same BWP ID may be linked to each other, and the DL BWP and the UL BWP having the same BWP ID may be activated. In the TDD band, center frequencies of the DL BWP and the UL BWP may be the same.

The terminal may receive a DL channel (e.g., PDCCH and/or PDSCH) based on an SCS and a CP length configured for the active DL BWP in the active DL BWP. The terminal may transmit a UL channel (e.g., PUCCH and/or PUSCH) based on an SCS and a CP length configured for the active UL BWP in the active UL BWP.

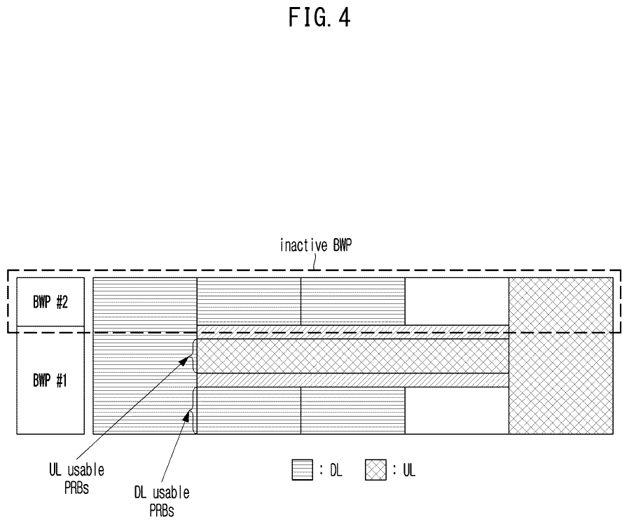

FIG. 4 is a conceptual diagram illustrating exemplary embodiments of BWP configuration in a communication system supporting SBFD.

Referring to FIG. 4, resources in a communication system may be configured based on a combination of SBFD configuration and BWP configuration. A plurality of BWPs (e.g., BWP #1 and BWP #2) may be configured, BWP #1 may be activated, and BWP #2 may be deactivated. UL/DL subbands for SBFD may be configured in the second slot and the third slot in the time domain. For SBFD symbols in which UL/DL subbands are configured, resource regions (e.g., PRBs) actually available for UL/DL communication may be defined as follows.
UL usable PRBs: a frequency resource region of the UL subband within the active UL BWP
DL usable PRBs: a frequency resource region of the DL subband within the active DL BWP

In the SBFD symbols, the base station and/or the terminal may perform UL communication through the UL usable PRBs within the active UL BWP and may perform DL communication through the DL usable PRBs within the active DL BWP.

In the communication system supporting SBFD, the base station may provide RACH configuration information to the terminal through higher layer signaling (e.g., SIB or RRC signaling). For RACH configuration, the following two configuration methods may be used.
RACH configuration method #1: one piece of RACH configuration information may be provided to the terminal, and the RACH configuration information may be applied to both SBFD symbols (e.g., SBFD resources) and N-SBFD symbols (for example, N-SBFD resources). In other words, the terminal may receive one piece of RACH configuration information from the base station and may perform transmission of a random access preamble (e.g., PRACH transmission) in SBFD symbols and N-SBFD symbols based on the received RACH configuration information.
RACH configuration method #2: two pieces of RACH configuration information may be provided to the terminal. One piece of RACH configuration information (e.g., legacy RACH configuration information) may be applied to N-SBFD symbols (e.g., N-SBFD resources), and the other piece of RACH configuration information (e.g., SBFD RACH configuration information, additional RACH configuration information) may be applied to SBFD symbols (e.g., SBFD resources).

One of RACH configuration method #1 or RACH configuration method #2 may be used based on configuration of the base station.

### First Exemplary Embodiment: Method of Determining a PRACH Transmission Occasion in the Frequency Domain

In a communication system, various parameters for determining time resources and/or frequency resources in which PRACH may be transmitted for transmission of a random access preamble may be configured, and a PRACH transmission occasion may be determined based on the configuration information (e.g., parameters). A PRACH transmission occasion may be referred to as a RACH occasion (RO). For example, to configure frequency domain resources of ROs, the following parameter(s) may be configured for the terminal through signaling of the base station. The following parameter(s) may be included in the RACH configuration information.
Number of PRACH transmission occasions multiplexed in the frequency domain (hereinafter referred to as ‘N_FDM’). N_FDM may mean msg1-FDM.
A location of PRACH transmission occasions in the frequency domain (hereinafter referred to as ‘N_offset’). N_offset may indicate an offset from a PRB having the lowest index within a UL bandwidth. N_offset may mean msg1-FrequencyStart.

In the communication system supporting SBFD, the base station may provide RACH configuration information to the terminal based on RACH configuration method #1. In other words, the base station may provide one piece of RACH configuration information to the terminal, and the terminal may determine all PRACH transmission occasions in N-SBFD symbols and SBFD symbols based on the one piece of RACH configuration information.

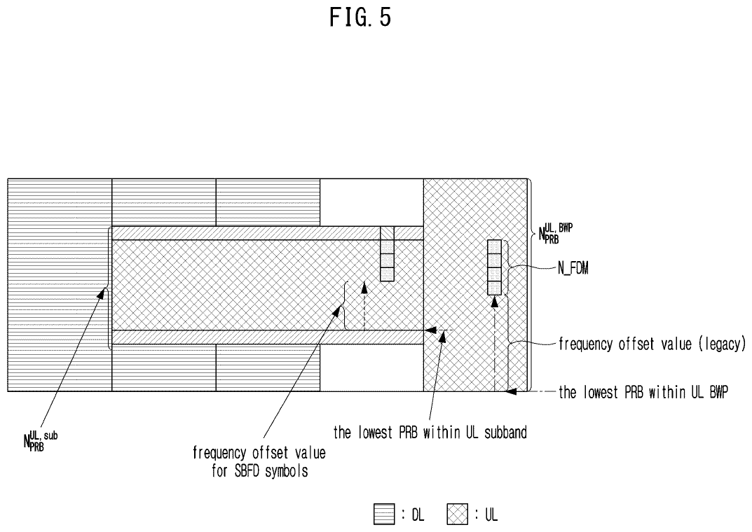

FIG. 5 is a conceptual diagram illustrating configuration of PRACH transmission occasions based on RACH configuration method #1 in a communication system supporting SBFD.

Referring to FIG. 5, the base station may provide N_FDM and N_offset values to the terminal to determine frequency domain resources of PRACH transmission occasions. N_FDM and N_offset may be determined with respect to a UL BWP of N-SBFD symbols. The terminal may determine a frequency domain location of PRACH transmission occasions in N-SBFD symbols based on N_FDM and N_offset. When the terminal applies N_FDM and N_offset as they are to a UL subband of SBFD symbols, a frequency domain location of PRACH transmission occasions may not be determined properly depending on a frequency domain location and a bandwidth size of the UL subband. In particular, as in the exemplary embodiment illustrated in FIG. 5, when a UL BWP bandwidth of N-SBFD symbols is larger than a UL subband bandwidth of SBFD symbols, if the terminal applies N_FDM and N_offset as they are in SBFD symbols, some PRACH transmission occasions (e.g., some PRBs of PRACH transmission occasions) may fall outside the bandwidth of the UL subband. Some PRACH transmission occasions falling outside the bandwidth of the UL subband may be invalid.

When the UL BWP is configured with 100 RBs in N-SBFD symbols, the UL subband is configured with 20 RBs in SBFD symbols, and one PRACH transmission occasion is defined in one RB, if the base station configures N_FDM=1 and N_offset=15, the terminal may determine one PRB #25 as a PRACH transmission occasion starting from a PRB spaced by N_offset from a PRB #0 having the lowest index within the UL BWP in N-SBFD symbols. When the terminal applies N_offset based on the PRB #0 having the lowest index within the UL subband in SBFD symbols, a PRACH transmission occasion may fall outside the bandwidth of the UL subband, and the PRACH transmission occasion may not be defined based on N_offset.

In the present disclosure, a bandwidth size of the UL subband (e.g., the number of PRBs of the UL subband) may be defined as BW_sub, and a bandwidth size of the UL BWP (e.g., the number of PRBs of the UL BWP) may be defined as BW_ul.

When the UL BWP is configured with 100 RBs in N-SBFD symbols, the UL subband is configured with 20 RBs in SBFD symbols, and one PRACH transmission occasion is defined in one RB, if the base station configures N_FDM=8 and N_offset=15, the terminal may determine 8 PRBs {PRB #15, PRB #16, . . . , PRB #22} as PRACH transmission occasions starting from a PRB spaced by N_offset from the PRB #0 having the lowest index within the UL BWP in N-SBFD symbols. When the terminal applies N_offset based on the PRB #0 having the lowest index within the UL subband in SBFD symbols, 6 PRACH transmission occasions multiplexed in the frequency domain may be configured. In other words, 6 PRBs {PRB #15, PRB #16, PRB #17, PRB #18, PRB #19, PRB #20} may be determined as PRACH transmission occasions. When N_FDM is configured to 8, 8 PRACH transmission occasions multiplexed in the frequency domain may not be guaranteed.

To solve the above-described problem, method(s) of reinterpreting N_offset and N_FDM so that PRACH transmission occasions are always defined within the UL subband of SBFD symbols regardless of N_offset and N_FDM may be proposed.

When the terminal receives RACH configuration information from the base station based on RACH configuration method #1 in the communication system supporting SBFD, the terminal may determine a frequency domain location of PRACH transmission occasions within the UL subband of SBFD symbols based on the RACH configuration information. When the terminal applies N_offset and N_FDM indicated by the RACH configuration information within the UL subband of SBFD symbols, the terminal may reinterpret and apply N_offset and/or N_FDM based on the following method.

### (N_Offset Reinterpretation Method #1)

The terminal may define PRACH transmission occasions from a PRB to which an offset of N_offset_sbfd is applied starting from a PRB having the lowest index within the UL subband of SBFD symbols. N_offset_sbfd may be defined based on Equation 1 below.

$$N\_offset \_sbfd = floor ( N\_offset * K ) \qquad [ Equation l ]$$

In Equation 1, floor(x) may be a function outputting the maximum integer equal to or less than x. K may be defined as a ratio of a bandwidth size of the UL subband to a bandwidth size of the UL BWP. For example, K may be defined as BW_sub/BW_ul.

### (N_Offset Reinterpretation Method #2)

The terminal may define PRACH transmission occasions from a PRB to which an offset of N_offset_sbfd is applied starting from a PRB having the lowest index within the UL subband of SBFD symbols. N_offset_sbfd may be defined based on Equation 2 below.

$$N\_offset \_sbfd = N\_offset * K \qquad [ Equation 2 ]$$

K may be defined as a ratio of a bandwidth size of the UL subband to a bandwidth size of the UL BWP. For example, K may be defined as floor(BW_sub/BW_ul).

### (N_FDM Reinterpretation Method #1)

The terminal may define N_FDM PRACH transmission occasions from a PRB to which an offset of N_offset_sbfd is applied starting from a PRB having the lowest index within the UL subband of SBFD symbols. To ensure that a PRB corresponding to a PRACH transmission occasion in the frequency domain does not fall outside the UL subband bandwidth, a modulo operation using the bandwidth size of the UL subband may be applied. For example, when N_offset_sbfd=K and N_FDM=M, if the PRB having the lowest index of the UL subband of SBFD symbols is a PRB #X, a PRB corresponding to an m-th PRACH transmission occasion among M PRACH transmission occasions multiplexed in the frequency domain may be defined based on Equation 3 below.

$$PRB \# ( mod ( X + N\_offset \_sbfd + m - 1 , BW\_sub ) ) \qquad [ Equation 3 ]$$

In Equation 3, mod(A,B) may correspond to a modulo operator outputting a remainder obtained by dividing A by B.

### (N_FDM Reinterpretation Method #2)

The terminal may define N_FDM PRACH transmission occasions from a PRB to which an offset of N_offset_sbfd is applied starting from a PRB having the lowest index within the UL subband of SBFD symbols. When a PRB corresponding to a PRACH transmission occasion in the frequency domain falls outside the UL subband bandwidth, the terminal may determine the PRACH transmission occasion to be invalid and may ignore the PRACH transmission occasion.

In other words, the terminal may determine a starting PRB of SBFD ROs (e.g., additional ROs) by applying the offset (e.g., N_offset_sbfd) included in RACH configuration information to the PRB having the lowest index within the UL subband. The starting PRB of the SBFD ROs may be a PRB having the lowest index among PRBs included in the SBFD ROs. An ending PRB of the SBFD ROs may be a PRB having the highest index among the PRBs included in the SBFD ROs. In the frequency domain, the starting PRB of the SBFD ROs may be located after the offset from the PRB having the lowest index within the UL subband. When at least one PRB (e.g., the ending PRB) of an SBFD RO is located outside the UL subband, the terminal may determine the SBFD RO to be an invalid RO. The terminal may not perform PRACH transmission in the invalid RO. The base station may not expect to receive PRACH in the invalid RO.

Based on the first exemplary embodiment described above, when a frequency domain location and a bandwidth size of the UL BWP are different from a frequency domain location and a bandwidth size of the UL subband, a PRACH transmission occasion in the UL subband of SBFD symbols may be effectively determined based on one configuration parameter.

In the communication system supporting SBFD, when the terminal receives RACH configuration information from the base station, the terminal may determine a frequency domain location of a PRACH transmission occasion in the UL subband of SBFD symbols based on the RACH configuration information. To determine the frequency domain location of the PRACH transmission occasion, the terminal may determine whether to reinterpret UL subband configuration information and/or TDD configuration information. The terminal may determine the frequency domain location of the PRACH transmission occasion based on reinterpretation of UL subband configuration information and/or TDD configuration information. Alternatively, the terminal may determine the frequency domain location of the PRACH transmission occasion by applying the UL subband configuration information and/or the TDD configuration information as they are. For example, the terminal may determine whether to reinterpret based on the following conditions.

When a ratio of the size of the UL subband to the size of the UL BWP is less than (or greater than) a specific threshold, the terminal may apply reinterpretation of the UL subband configuration information and/or the TDD configuration information. When assuming the UL subband size as X and assuming the UL BWP size as Y, if X/Y<θ, the terminal may apply reinterpretation of the UL subband configuration information and/or the TDD configuration information. θ may be a predefined threshold. If X/Y>θ, the terminal may not apply reinterpretation of the UL subband configuration information and/or the TDD configuration information. Conversely, if Y/X>θ, the terminal may apply reinterpretation of the UL subband configuration information and/or the TDD configuration information, and if X/Y<θ, the terminal may not apply reinterpretation of the UL subband configuration information and/or the TDD configuration information.

When the size of the UL subband is less than (or greater than) a specific threshold, the terminal may apply reinterpretation of the UL subband configuration information and/or the TDD configuration information. When assuming the UL subband size as X, if X<θ, the terminal may apply reinterpretation of the UL subband configuration information and/or the TDD configuration information, and if X>θ, the terminal may not apply reinterpretation of the UL subband configuration information and/or the TDD configuration information. θ may be a predefined threshold.

The base station and/or the terminal may apply reinterpretation to PRACH transmission occasions so as to include SBFD symbols that are configured in DL resources. Specifically, the base station and/or the terminal may apply reinterpretation to determine a frequency domain resource location of additional ROs based on the following definition.

For RACH configuration option 1 (e.g., RACH configuration method #1), additional ROs may include ROs within SBFD symbols configured in DL resources by tdd-UL-DL-ConfigurationCommon, and may include ROs across SBFD symbols configured in DL resources and SBFD symbols configured in FL resources by tdd-UL-DL-ConfigurationCommon.

Among the SBFD symbols, the terminal may not apply reinterpretation for ROs existing in SBFD symbols configured in FL symbols.

The terminal may determine PRACH transmission occasions in the frequency domain of the UL subband, and the terminal may perform PRACH transmission based on the method of determining PRACH transmission resources.

### Second Exemplary Embodiment: Method for Determining a PRACH Transmission Occasion in the Time Domain

The terminal may determine valid PRACH transmission occasion(s) among PRACH transmission occasions in the time domain based on PRACH configuration information (e.g., RACH configuration information).

For FDD or SUL, the terminal may determine all PRACH transmission occasions indicated by the PRACH configuration information in the time domain to be valid.

For TDD, when configuration information for a TDD UL/DL pattern is not provided to the terminal, the terminal may perform the following operation.
The terminal may determine a PRACH transmission occasion within a PRACH slot existing at least N_{gap} symbols after the last SSB among configured PRACH transmission occasions to be valid. N_{gap} may be defined as a different value for each subcarrier spacing. For example, N_{gap} may be determined based on Table 3 described above.

For TDD, when configuration information for a TDD UL/DL pattern is provided to the terminal, the terminal may determine validity of a PRACH transmission occasion based on the following methods.
The terminal may determine a PRACH transmission occasion within UL symbols indicated by the TDD pattern configuration to be valid.
Alternatively, the terminal may determine a PRACH transmission occasion within a PRACH slot existing at least N_{gap} symbols after the last SSB to be valid.

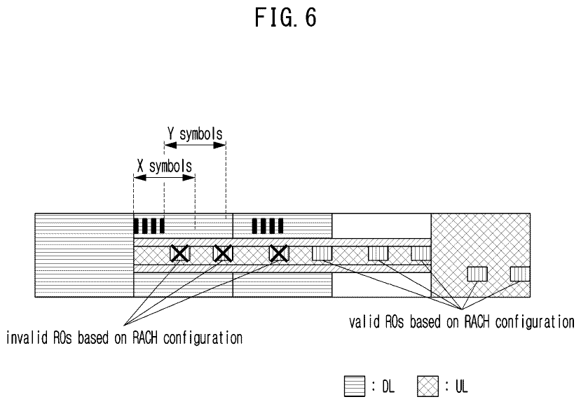

FIG. 6 is a conceptual diagram illustrating exemplary embodiments of PRACH transmission resources (e.g., PRACH transmission occasions) in a communication system supporting SBFD.

Referring to FIG. 6, the terminal may receive RACH configuration information from the base station, and the terminal may determine PRACH transmission occasions in the time domain based on the received RACH configuration information. The base station may configure PRACH transmission occasions across SBFD symbols and N-SBFD symbols. The terminal may determine some PRACH transmission occasions among PRACH transmission occasions configured by the base station to be valid when the some PRACH transmission occasions satisfy specific conditions.

The terminal may determine PRACH transmission occasion(s) satisfying the following conditions among PRACH transmission occasions configured in SBFD symbols to be valid.
Condition #1: The terminal may determine PRACH transmission occasion(s) that have time and frequency resources existing within UL usable PRBs in SBFD symbols among PRACH transmission occasions configured by the base station and do not overlap with SSB to be valid.
Condition #2: The terminal may determine PRACH transmission occasion(s) existing X symbols after the last N-SBFD symbol (e.g., the last DL symbol) among PRACH transmission occasions configured by the base station to be valid. X may be a natural number. X may be a value configured for the terminal through higher layer signaling. When X is not configured for the terminal, X may be N_{gap}. N_{gap} may be configured based on a subcarrier spacing of the preamble. N_{g}ap may be determined based on Table 3.
Condition #3: The terminal may determine PRACH transmission occasion(s) existing Y symbols after the last SSB symbol among PRACH transmission occasions configured by the base station to be valid. Y may be a natural number. Y may be defined as a fixed value. For example, Y may be N_{g}ap. N_{gap} may be configured based on a subcarrier spacing of the preamble. N_{gap} may be determined based on Table 3.
Condition #4: A PRACH slot including a valid PRACH transmission occasion may not always precede SSB.

The procedure of determining validity for a PRACH transmission occasion may be selectively applied when DL symbols based on a TDD UL/DL configuration are configured as SBFD symbols.

### Third Exemplary Embodiment: Association Method Between PRACH Transmission Occasions and SSBs

The terminal may associate valid PRACH transmission occasions determined among PRACH transmission occasions configured by the base station with SSB indexes based on a specific rule. For example, mapping relations between SSBs and PRACH transmission occasions may be determined based on the following priorities.

### [SSB-RO Mapping Method #0]

First, for one PRACH transmission occasion, the base station and/or the terminal may map SSB indexes to the PRACH transmission occasions in an order in which preamble indexes increase.
Second, for PRACH transmission occasions multiplexed in the frequency domain, the base station and/or the terminal may map SSB indexes to the PRACH transmission occasions in an order in which frequency resource indexes increase.
Third, for PRACH transmission occasions multiplexed in the time domain within one PRACH slot, the base station and/or the terminal may map SSB indexes to the PRACH transmission occasions in an order in which time resource indexes increase.
Fourth, the base station and/or the terminal may map SSB indexes to PRACH transmission occasions in an order in which indexes of PRACH slots increase.

For a designated preamble index, an indexing order of PRACH transmission occasions may be determined as follows.

### [PRACH Indexing Method #0]

First, for PRACH transmission occasions multiplexed in the frequency domain, the base station and/or the terminal may determine indexes of the PRACH transmission occasions in an order in which frequency resource indexes increase.
Second, for PRACH transmission occasions multiplexed in the time domain, the base station and/or the terminal may determine indexes of the PRACH transmission occasions in an order in which time resource indexes increase.
Third, the base station and/or the terminal may determine indexes of PRACH transmission occasions in an order in which indexes of PRACH slots increase.

Meanwhile, in order to effectively manage PRACH transmission between the existing terminals (e.g., legacy terminals) incapable of recognizing SBFD and new terminals (e.g., SBFD terminals) capable of recognizing SBFD in the communication system supporting SBFD, a new mapping method between PRACH transmission occasions and SSB indexes may be required.

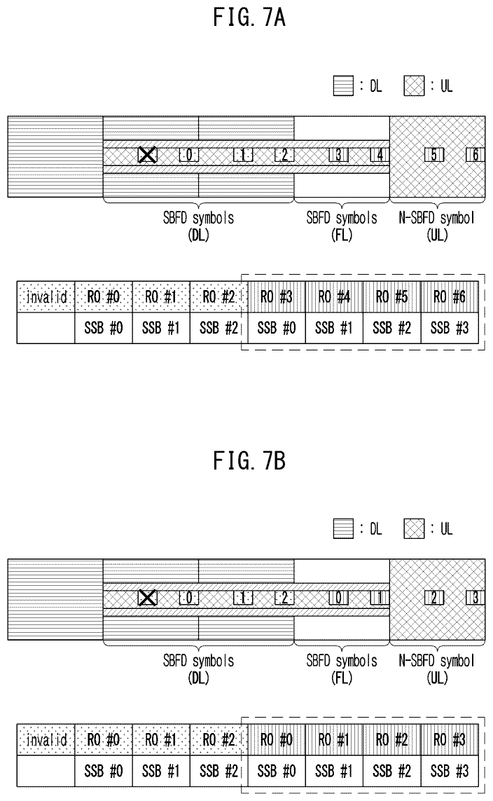

FIG. 7A and FIG. 7B are conceptual diagrams illustrating a PRACH transmission occasion indexing method and an SSB index mapping method in a communication system supporting SBFD.

An exemplary embodiment illustrated in FIG. 7A may correspond to a unified PRACH transmission occasion indexing and SSB mapping method. An exemplary embodiment illustrated in FIG. 7B may correspond to a PRACH transmission occasion indexing method and an SSB mapping method which are independent from each other.

Referring to FIG. 7A and FIG. 7B, when valid PRACH transmission occasions are configured across SBFD symbols and N-SBFD symbols, a legacy terminal may consider mapping relations between PRACH transmission occasion(s) existing in N-SBFD symbols and SSB indexes, and a new terminal may consider mapping relations between PRACH transmission occasion(s) existing in SBFD symbols as well as in N-SBFD symbols and SSB indexes. In this case, the base station may configure valid PRACH transmission and reception to be performed by allowing the legacy terminal and the new terminal to apply the same mapping relation between PRACH transmission occasion(s) and SSB indexes in N-SBFD symbols. The base station may allow effective PRACH transmission of the new terminal by applying a cyclic mapping relation between PRACH transmission occasion(s) in SBFD symbols and SSB indexes. In order to solve the above-described problem, various mapping methods between PRACH transmission occasions and SSB indexes and various methods of PRACH index ordering are presented. In the present disclosure, a terminal may be interpreted as an existing terminal (e.g., legacy terminal) or a new terminal (e.g., SBFD terminal) depending on context.

When PRACH transmission occasions are configured across SBFD symbols and N-SBFD symbols, the SBFD terminal may independently map SSB indexes to PRACH transmission occasions existing in SBFD symbols and PRACH transmission occasions existing in N-SBFD symbols. In other words, the terminal may apply SSB index mapping based on SSB-RO mapping method #0 for the respective PRACH transmission occasions existing in SBFD symbols, and the terminal may apply SSB index mapping based on SSB-RO mapping method #0 for the respective PRACH transmission occasions existing in N-SBFD symbols.

When PRACH transmission occasions are configured across SBFD symbols and N-SBFD symbols, the SBFD terminal may independently map SSB indexes to PRACH transmission occasions existing in SBFD symbols and PRACH transmission occasions existing in N-SBFD symbols. In other words, the terminal may apply SSB index mapping for the respective PRACH transmission occasions existing in SBFD symbols, and the terminal may apply SSB index mapping for the respective PRACH transmission occasions existing in N-SBFD symbols. In this case, the terminal may consider the following mapping method.

### [SSB-RO Mapping Method #1]

First, for one PRACH transmission occasion, the base station and/or the terminal may map an SSB index to the PRACH transmission occasion in an order in which preamble indexes increase.
Second, for PRACH transmission occasions multiplexed in the frequency domain, the base station and/or the terminal may map SSB indexes to the PRACH transmission occasions in an order in which frequency resource indexes increase.
Third, for PRACH transmission occasions multiplexed in the time domain within one PRACH slot, the base station and/or the terminal may map SSB indexes to the PRACH transmission occasions in an order in which time resource indexes increase.
Fourth, the base station and/or the terminal may map SSB indexes to PRACH transmission occasions in an order in which indexes of PRACH slots increase.
Fifth, the base station and/or the terminal may map SSB indexes in an order of PRACH transmission occasions within SBFD symbols configured in FL symbols indicated by a TDD UL/DL pattern configuration, PRACH transmission occasions within N-SBFD symbols configured in UL symbols indicated by the TDD UL/DL pattern configuration, and lastly PRACH transmission occasions within SBFD symbols configured in DL symbols indicated by the TDD UL/DL pattern configuration.

When PRACH transmission occasions are configured across SBFD symbols and N-SBFD symbols, for a designated preamble index, the SBFD terminal may define an indexing order of PRACH transmission occasions for SBFD symbols and N-SBFD symbols in a unified manner. The above-described operation may correspond to the exemplary embodiment illustrated in FIG. 7A. For example, the terminal may follow the following method.

### [PRACH Indexing Method #1]

First, for PRACH transmission occasions multiplexed in the frequency domain, the base station and/or the terminal may determine indexes of the PRACH transmission occasions in an order in which frequency resource indexes increase.
Second, for PRACH transmission occasions multiplexed in the time domain, the base station and/or the terminal may determine indexes of the PRACH transmission occasions in an order in which time resource indexes increase.
Third, the base station and/or the terminal may determine indexes of PRACH transmission occasions in an order in which indexes of PRACH slots increase.
Fourth, the base station and/or the terminal may determine indexes of PRACH transmission occasions in an order of PRACH transmission occasions within SBFD symbols configured in DL symbols indicated by a TDD UL/DL pattern configuration, PRACH transmission occasions within SBFD symbols configured in FL symbols indicated by the TDD UL/DL pattern configuration, and lastly PRACH transmission occasions within N-SBFD symbols configured in UL symbols indicated by the TDD UL/DL pattern configuration.

When PRACH transmission occasions are configured across SBFD symbols and N-SBFD symbols, for a designated preamble index, the SBFD terminal may independently define an indexing order of PRACH transmission occasions for SBFD symbols and N-SBFD symbols. In the time domain, SBFD resources and N-SBFD resources may be configured consecutively. One or more ROs may be configured in SBFD resources, and a type of one or more ROs configured in SBFD resources may be additional RO (e.g., SBFD RO). A type of one or more ROs configured in SBFD resources within a DL region may be determined to be additional RO. A type of one or more ROs configured in SBFD resources within an FL region may be determined to be additional RO or legacy RO. One or more ROs may be configured in N-SBFD resources, and a type of the one or more ROs configured in N-SBFD resources may be legacy RO (e.g., N-SBFD RO).

For example, the communication node (e.g., the base station and/or the terminal) may determine respective indexes of SBFD ROs configured in SBFD resources. An index of each of the SBFD ROs may be determined as 0, 1, 2, and so on. The communication node may determine respective indexes of legacy ROs configured in N-SBFD resources after the SBFD resources. The communication node may perform indexing for the legacy ROs independently of indexing for the SBFD ROs. An index of each of the legacy ROs may be determined as 0, 1, 2, and so on. In another example, the communication node (e.g., the base station and/or the terminal) may determine respective indexes of legacy ROs configured in N-SBFD resources. An index of each of the legacy ROs may be determined as 0, 1, 2, and so on. The communication node may determine respective indexes of SBFD ROs configured in SBFD resources after the N-SBFD resources. The communication node may perform indexing for the SBFD ROs independently of indexing for the legacy ROs. An index of each of the SBFD ROs may be determined as 0, 1, 2, and so on. The above-described operation may correspond to the exemplary embodiment illustrated in FIG. 7B. For example, the terminal may apply the following method.

### [PRACH Indexing Method #2]

First, the base station and/or the terminal may perform indexing for SBFD ROs and indexing for legacy ROs independently. For example, the base station and/or the terminal may determine respective indexes of the SBFD ROs as 0, 1, 2, and so on, and may determine respective indexes of the legacy ROs as 0, 1, 2, and so on. Indexes of the SBFD ROs and indexes of the legacy ROs may not be associated with each other, and indexes of the SBFD ROs and indexes of the legacy ROs may be configured independently.
Second, for SBFD ROs multiplexed in the frequency domain, the base station and/or the terminal may determine indexes of the SBFD ROs in an order in which frequency resource indexes increase. For legacy ROs multiplexed in the frequency domain, the base station and/or the terminal may determine indexes of the legacy ROs in an order in which frequency resource indexes increase.
Third, for SBFD ROs multiplexed in the time domain, the base station and/or the terminal may determine indexes of the SBFD ROs in an order in which time resource indexes increase. For legacy ROs multiplexed in the time domain, the base station and/or the terminal may determine indexes of the legacy ROs in an order in which time resource indexes increase.
Fourth, the base station and/or the terminal may determine indexes of the SBFD ROs in an order in which indexes of PRACH slots increase. The base station and/or the terminal may determine indexes of the legacy ROs in an order in which indexes of PRACH slots increase.

With respect to a RACH configuration scheme, the base station may apply one of the following two options.

(RACH configuration option 1)

One single RACH configuration may be used, and operations of the communication node (e.g., the base station and/or the terminal) may be based on existing parameters of the single RACH configuration

### (RACH Configuration Option 2)

Two separate RACH configurations including one legacy RACH configuration and one additional RACH configuration may be used.

In the present disclosure, additional ROs (e.g., SBFD ROs) may be defined as follows.

For RACH configuration option 1, the additional ROs may include ROs within SBFD symbols configured in DL resources indicated by tdd-UL-DL-ConfigurationCommon, and may include ROs across SBFD symbols configured in DL resources indicated by tdd-UL-DL-ConfigurationCommon and SBFD symbols configured in FL resources indicated by tdd-UL-DL-ConfigurationCommon.

For RACH configuration option 2, the additional ROs may be ROs configured by the additional RACH configuration.

The SBFD terminal (e.g., SBFD-aware UE) may acquire RACH configuration information based on RACH configuration option 2. In other words, the terminal may receive from the base station legacy RACH configuration information (hereinafter referred to as ‘RACH configuration #0’ or ‘RACH configuration information #0’, or ‘legacy RACH configuration information’) and additional RACH configuration information (hereinafter referred to as ‘RACH configuration #1’, ‘RACH configuration information #1’, or ‘SBFD RACH configuration information’). The terminal may determine valid ROs based on RACH configuration #0 and RACH configuration #1. ROs configured based on RACH configuration #1 may be defined as additional ROs. The terminal may determine additional ROs configured in N-SBFD symbols by RACH configuration #1 to be invalid.

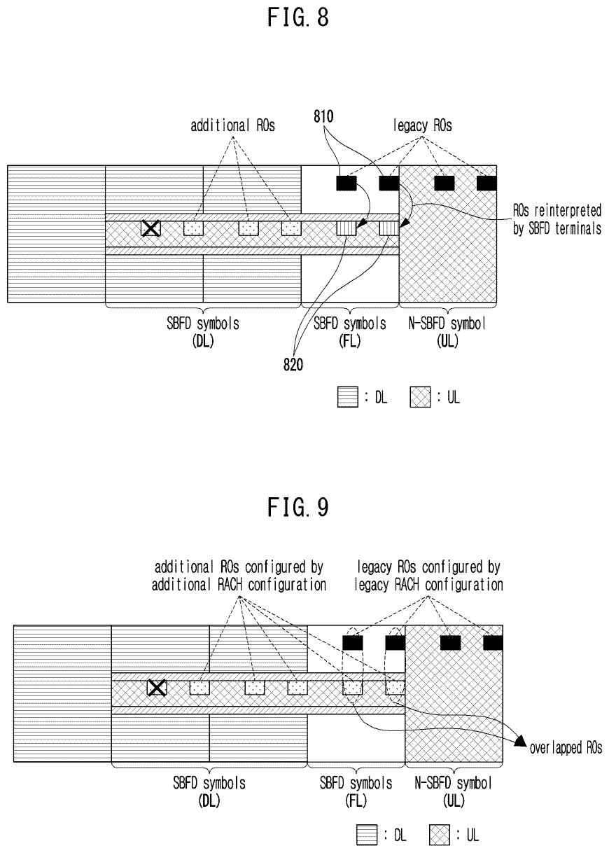

FIG. 8 is a conceptual diagram illustrating a RACH configuration based on RACH configuration option 1.

Referring to FIG. 8, among ROs configured based on the above definition, ROs existing in SBFD symbols within DL resources may be additional ROs. Among the ROs configured based on the above definition, ROs existing in SBFD symbols within FL resources or ROs existing in N-SBFD symbols may be existing ROs (hereinafter referred to as ‘legacy ROs’). The existing terminal (e.g., legacy terminal, SBFD-unaware terminal) may determine legacy ROs to be valid. Ambiguity for frequency-domain resources of ROs existing in SBFD symbols within FL resources among the legacy ROs may occur in the SBFD terminal. In other words, ambiguity for an interpretation of frequency-domain resources of the ROs may occur. For example, for the ambiguous ROs, the SBFD terminal may determine whether to assume PRACH frequency-domain resources (e.g., 810 illustrated in FIG. 8) determined according to a RACH configuration or to assume PRACH frequency-domain resources (e.g., 820 illustrated in FIG. 8) reinterpreted based on the RACH configuration. For example, the following methods may be considered.
For ROs existing in SBFD symbols within FL resources among ROs indicated by the RACH configuration, the SBFD terminal may determine RO frequency resources based on the received RACH configuration information without applying reinterpretation for PRACH frequency resources. In other words, the SBFD terminal may determine the ROs 810 existing in SBFD symbols within FL resources in FIG. 8 to be valid. In this case, the SBFD terminal may determine even ROs existing outside the UL subband in SBFD symbols within FL resources to be valid.
For ROs existing in SBFD symbols within FL resources among ROs indicated by the RACH configuration, the SBFD terminal may apply reinterpretation for PRACH frequency resources to determine RO frequency resources existing within UL usable PRBs, and the SBFD terminal may determine the reinterpreted ROs to be valid. In other words, the SBFD terminal may determine the ROs 820 existing in the UL subband in SBFD symbols within FL resources in FIG. 8 to be valid. In this case, for the SBFD terminal, it may be possible that PRACH transmission resources are always located within the UL subband in SBFD symbols within FL resources.
For ROs existing in SBFD symbols within FL resources among ROs indicated by the RACH configuration, the SBFD terminal may determine both ROs existing within RO frequency resources based on the received RACH configuration information and ROs existing within UL usable PRBs to which reinterpretation for PRACH frequency resources is applied to be valid. In other words, the SBFD terminal may determine both ROs 810 and 820 existing in SBFD symbols within FL resources in FIG. 8 to be valid. In this case, the SBFD terminal may obtain many PRACH transmission occasions within FL resources in SBFD symbols.
For ROs existing in SBFD symbols within FL resources among ROs indicated by the RACH configuration, the SBFD terminal may determine only ROs existing within UL usable PRBs to be valid. The terminal may determine ROs not existing within UL usable PRBs among ROs existing in SBFD symbols within FL resources indicated by the RACH configuration to be invalid. In the exemplary embodiment of FIG. 8, the SBFD terminal may determine that the ROs 810 existing in SBFD symbols within FL resources are invalid because the ROs do not exist within the UL subband, and the SBFD terminal may not perform PRACH transmission in the ROs 810.

FIG. 9 is a conceptual diagram illustrating a RACH configuration based on RACH configuration option 2.

Referring to FIG. 9, among the ROs configured based on the above definition, ROs configured by RACH configuration #0 may be legacy ROs. Among the ROs configured based on the above definition, ROs configured by RACH configuration #1 may be additional ROs. The legacy terminal may determine the legacy ROs to be valid. The SBFD terminal may determine both legacy ROs and additional ROs to be valid. Some of the legacy ROs and additional ROs may overlap in a time or frequency resource region. For example, a legacy RO and an additional RO existing in SBFD symbols within FL resources may overlap in a time or frequency resource region. FIG. 9 illustrate an exemplary embodiment in which a legacy RO and an additional RO existing in SBFD symbols within FL resources overlap in a partial time region. In this case, in the SBFD terminal, an ambiguous problem may occur as to whether to determine a PRACH transmission resource for the overlapped RO based on the legacy RO or to determine a PRACH transmission resource for the overlapped RO based on the additional RO. To solve the above problem, the following methods may be considered.
When a legacy RO and an additional RO overlap in a time and/or frequency resource region, the SBFD terminal may determine the legacy RO to be valid and may ignore the additional RO. The SBFD terminal may perform a PRACH transmission for the overlapped RO based on the legacy RO. According to the above operation, the SBFD terminal may effectively coexist with the legacy terminal.
When a legacy RO and an additional RO overlap in a time and/or frequency resource region, the SBFD terminal may determine the additional RO to be valid and may ignore the legacy RO. The SBFD terminal may perform a PRACH transmission for the overlapped RO based on the additional RO. According to the above operation, PRACH transmission efficiency of the SBFD terminal may be improved.
When a legacy RO and an additional RO overlap in a time and/or frequency resource region, the SBFD terminal may determine both the legacy RO and the additional RO to be valid. The SBFD terminal may perform a PRACH transmission for the overlapped RO based on the legacy RO and the additional RO. According to the above operation, PRACH transmission efficiency of the SBFD terminal may be improved.
When a legacy RO and an additional RO overlap in a time and/or frequency resource region, the SBFD terminal may determine both the legacy RO and the additional RO to be invalid. The SBFD terminal may not perform a PRACH transmission in the overlapped RO.
The SBFD terminal may not expect that a legacy RO and an additional RO are configured to overlap in a time and/or frequency resource region. In other words, when the legacy RO and the additional RO overlap in a time and/or frequency resource region, the terminal may determine the RO configuration to be an error.

### Fourth Exemplary Embodiment: Random Access Procedure Based on a PDCCH Order

In the communication system (e.g., NR communication system), the terminal may receive a PDCCH order from the base station, and the terminal may perform a random access procedure based on the PDCCH order. One of a Contention-based Random Access (CBRA) procedure and a Contention-free Random Access (CFRA) procedure may be triggered by the PDCCH order. When the CFRA procedure is triggered by the PDCCH order, the base station may indicate a PRACH preamble index, an SSB index, and/or a PRACH mask index to the terminal through the PDCCH order delivered with DCI format 1_0. The terminal may determine an RO (e.g., PRACH transmission occasion) to be used for the random access procedure and a random access preamble based on the DCI received from the base station (e.g., the PDCCH order). When the CBRA procedure is triggered by the PDCCH order, the terminal may transmit a PRACH by selecting a random access preamble and an RO by the terminal itself.

The DCI corresponding to the PDCCH order may be configured as follows.

DCI format 1_0 may be used for scheduling of a PDSCH in one DL cell. The following information may be transmitted by DCI format 1_0 having cyclic redundancy check (CRC) bits scrambled by a cell (C)-RNTI, a configured scheduling (CS)-RNTI, or a modulation and coding scheme (MCS)-C-RNTI.
Identifier for DCI format: 1 bit. A value of the identifier field for DCI format may always be set to 1, and the identifier field set to 1 may indicate a DL DCI format.
Frequency domain resource assignment:

$$\begin{matrix}⌈ {log}_{2} ( {N}_{R B}^{DL , BWP} ( {N}_{R B}^{DL , BWP} + 1 ) / 2 ) ⌉ bits . \\ {N}_{R B}^{DL , BWP}\end{matrix}$$

may be defined in the technical specifications.

When CRC bits of DCI format 1_0 are scrambled by a C-RNTI and all bits of the frequency domain resource assignment field are set to 1, DCI format 1_0 may be for a random access procedure initiated by the PDCCH order, and the remaining fields of DCI format 1_0 may be configured as follows.
Random access preamble index: 6 bits according to ra-PreambleIndex defined in the technical specifications.
UL/SUL indicator: 1 bit. When all bits of the random access preamble index are not set to 0 and supplementary Uplink in ServingCellConfig is configured for the terminal in the cell, the UL/SUL indicator field may indicate a UL carrier in the cell for PRACH transmission according to the technical specifications. Otherwise, the UL/SUL indicator field may be reserved.
SS/PBCH index: 6 bits. When all bits of the random access preamble index are not set to 0, the SS/PBCH index field may indicate an SS/PBCH used to determine a RACH occasion for PRACH transmission. Otherwise, the SS/PBCH index field may be reserved.
PRACH mask index: 4 bits. When all bits of the random access preamble index are not set to 0, the PRACH mask index field may indicate a RACH occasion associated with an SS/PBCH indicated by the SS/PBCH index for PRACH transmission according to the technical specifications. Otherwise, the PRACH mask index field may be reserved.
Reserved bits: 10 bits.

Meanwhile, the base station may indicate to the terminal whether the terminal uses a legacy RO or an additional RO for PRACH transmission by using 1 bit of the PDCCH order. Information indicating whether the terminal uses a legacy RO or an additional RO for PRACH transmission may be referred to as an SBFD RO indicator (e.g., RO indicator). The SBFD RO indicator set to a first value (e.g., 0) may indicate that the terminal uses a legacy RO for PRACH transmission. The SBFD RO indicator set to a second value (e.g., 1) may indicate that the terminal uses an additional RO for PRACH transmission.

When a CFRA procedure is performed, the SBFD RO indicator (e.g., SBFD RO indicator field) may be included in the PDCCH order. When a CBRA procedure is performed, the SBFD RO indicator may be reserved. To perform a CFRA procedure triggered by the PDCCH order, the SBFD terminal may determine a type of RO (e.g., legacy RO or additional RO) for PRACH transmission based on the SBFD RO indicator. To perform a CBRA procedure triggered by the PDCCH order, the SBFD terminal may determine by itself a type of RO (e.g., legacy RO or additional RO) for PRACH transmission. The SBFD RO indicator (e.g., SBFD RO indicator field) may be defined as follows.
SBFD RO indicator: 1 bit. When all bits of the random access preamble index are not set to 0, the SBFD RO indicator field may indicate a type of RACH occasion for PRACH transmission, which is a legacy RO or an additional RO. Otherwise, the SBFD RO indicator field may be reserved.

When a CFRA procedure is triggered by the PDCCH order, the terminal may determine that the SBFD RO indicator field (e.g., a value of the SBFD RO indicator field) is valid. In other words, when the base station triggers a CBRA procedure to the terminal through the PDCCH order (i.e., when all bits of the random access preamble index field are set to 0), the terminal may ignore the SBFD RO indicator field (e.g., a value of the SBFD RO indicator field).

The SBFD RO indicator field may be valid when the terminal receives SBFD subband configuration information from the base station. In this case, the SBFD RO indicator field may be defined as follows.
SBFD RO indicator: 1 bit. When all bits of the random access preamble index field are not set to 0 and SBFD configuration is configured for the terminal in the cell, the SBFD RO indicator field may indicate a type of RACH occasion for PRACH transmission, which is a legacy RO or an additional RO. Otherwise, the SBFD RO indicator field may be reserved.

SBFD configuration (e.g., SBFD configuration information) may mean RRC parameter(s) corresponding to configuration related to SBFD (e.g., SBFD subband configuration).

The base station may indicate to the terminal a UL cell or an SUL cell as a UL cell for PRACH transmission through the PDCCH order. When the base station indicates a PRACH transmission in the SUL cell to the terminal, the PRACH transmission may be possible only through a legacy RO because the SBFD subband configuration does not exist in the indicated SUL cell. The SBFD RO indicator field may be valid only when the UL/SUL indicator field indicates a UL cell. The SBFD RO indicator field may be valid only when the SBFD RO indicator field indicates a legacy RO.

The terminal may determine the SBFD RO indicator field and the UL/SUL indicator field based on the following method(s).

### (Method #1: Determination of Validity of an SBFD RO Indicator Field Based on a Value of a UL/SUL Indicator Field)

UL/SUL indicator: 1 bit. When all bits of the random access preamble index field are not set to 0 and supplementaryUplink in ServingCellConfig is configured for the terminal in the cell, the UL/SUL indicator field may indicate a UL carrier in the cell for PRACH transmission according to the technical specifications. Otherwise, the UL/SUL indicator field may be reserved.
SBFD RO indicator: 1 bit. When all bits of the random access preamble index field are not set to 0 and the UL/SUL indicator indicates 1, the SBFD RO indicator field may indicate a type of RACH occasion for PRACH transmission, which is a legacy RO or an additional RO. Otherwise, the SBFD RO indicator field may be reserved.
In the above method, the UL/SUL indicator field set to 0 may be assumed to indicate a UL cell, and the UL/SUL indicator field set to 1 may be assumed to indicate an SUL cell.

### (Method #2: Determination of Validity of a UL/SUL Indicator Field Based on a Value of an SBFD RO Indicator Field)

UL/SUL indicator: 1 bit. When all bits of the random access preamble index field are not set to 0, the SBFD RO indicator is not 0, and supplementaryUplink in ServingCellConfig is configured for the terminal in the cell, the UL/SUL indicator field may indicate a UL carrier in the cell for PRACH transmission according to the technical specifications. Otherwise, the UL/SUL indicator field may be reserved.
SBFD RO indicator: 1 bit. When all bits of the random access preamble index field are not set to 0, the SBFD RO indicator field may indicate a type of RACH occasion for PRACH transmission, which is a legacy RO or an additional RO. Otherwise, the SBFD RO indicator field may be reserved.
In the above method, the SBFD RO indicator field set to 0 may be assumed to indicate a legacy RO, and the SBFD RO indicator field set to 1 may be assumed to indicate an additional RO.

The terminal may not expect that the UL/SUL indicator field in the PDCCH order (e.g., DCI) indicates an SUL cell and the SBFD RO indicator field indicates an additional RO. The following methods may be considered.
(Method #1) When the base station indicates a PRACH transmission in SUL (e.g., SUL cell) to the terminal (i.e., when the UL/SUL indicator field indicates SUL), the terminal may expect that the SBFD RO indicator field indicates a legacy RO, and the terminal may not expect that the SBFD RO indicator field indicates an additional RO.
(Method #2) When the base station indicates a PRACH transmission in SUL to the terminal (i.e., when the UL/SUL indicator field indicates SUL), the terminal may determine that the SBFD RO indicator field is invalid and may ignore the SBFD RO indicator field. In this case, the terminal may assume a type of RO as a legacy RO and may perform an RA procedure in the legacy RO.
(Method #3) When the base station indicates a PRACH transmission in an additional RO to the terminal (i.e., when the SBFD RO indicator field indicates an additional RO), the terminal may expect that the UL/SUL indicator field indicates UL, and the terminal may not expect that the UL/SUL indicator field indicates SUL.
(Method #4) When the base station indicates a PRACH transmission in an additional RO to the terminal (i.e., when the SBFD RO indicator field indicates an additional RO), the terminal may determine that the UL/SUL indicator field is invalid and may ignore the UL/SUL indicator field. In this case, the terminal may perform an RA procedure in UL.

The SBFD RO indicator field may be generated by using 1 reserved bit among fields in the existing DCI format corresponding to the PDCCH order.

Among fields in the existing DCI format corresponding to the PDCCH order, a specific field (e.g., a value of the specific field) may be reinterpreted as an SBFD RO indicator field. When a specific condition is satisfied, the UL/SUL indicator field may be reinterpreted as an SBFD RO indicator field. The SBFD terminal may secure a better uplink coverage compared to the existing terminal (e.g., legacy terminal) through the base station supporting SBFD operation. For the SBFD terminal, an RA procedure (e.g., PRACH transmission) using SUL (e.g., SUL cell) may not be supported, and only an RA procedure in the existing cell may be defined for the SBFD terminal. The SBFD terminal may determine that the UL/SUL indicator field among fields of the PDCCH order (e.g., DCI format) is invalid, and the SBFD terminal may interpret the UL/SUL indicator field as an SBFD RO indicator field.

Based on the above operation, the UL/SUL indicator field may be defined as follows.
UL/SUL indicator: 1 bit. When all bits of the random access preamble index field are not set to 0, SBFD configuration is not configured for the terminal in the cell, and supplementary Uplink in ServingCellConfig is configured for the terminal in the cell, the UL/SUL indicator field may indicate a UL carrier in the cell for PRACH transmission according to the technical specifications. When all bits of the random access preamble index field are not set to 0 and SBFD configuration is configured for the terminal in the cell, the UL/SUL indicator field may indicate a type of RACH occasion for PRACH transmission, which is a legacy RO or an additional RO. Otherwise, the UL/SUL indicator field may be reserved.

In the above operation, SBFD configuration (e.g., SBFD configuration information) may mean configuration information related to SBFD configured for the SBFD terminal (e.g., SBFD subband configuration, additional RO configuration, etc.).

The SBFD RO indicator field may always exist in the PDCCH order regardless of whether a CBRA procedure or a CFRA procedure is performed. The SBFD terminal may identify (e.g., determine) a type of RO (e.g., legacy RO or additional RO) for an RA procedure (e.g., a CBRA procedure or a CFRA procedure) triggered by the PDCCH order based on the SBFD RO indicator field. When the SBFD terminal performs a CBRA procedure triggered by the PDCCH order, the SBFD terminal may determine a type of RO (e.g., legacy RO or additional RO) for PRACH transmission based on a value of the SBFD RO indicator field. For the indicated RO type, the terminal may select a random access preamble, a random access transmission occasion, etc., by itself and may transmit PRACH. When the SBFD terminal performs a CFRA procedure triggered by the PDCCH order, the SBFD terminal may determine a type of RO (e.g., legacy RO or additional RO) for PRACH transmission based on a value of the SBFD RO indicator field. For the indicated RO type, the terminal may determine a random access occasion, a random access preamble, etc., used for the RA procedure based on information included in the DCI field (e.g., PDCCH order) received from the base station. Based on the above exemplary embodiment, the SBFD RO indicator field may be defined as follows.
SBFD RO indicator: 1 bit. The SBFD RO indicator field may indicate a type of RACH occasion for PRACH transmission, which is a legacy RO or an additional RO.

A combination of one or more of the exemplary embodiments of the present disclosure may be performed.

### Fifth Exemplary Embodiment: Power Control Method for PRACH

In the communication system (e.g., NR communication system), the terminal may determine a PRACH transmission power as follows.

The terminal may determine a PRACH transmission power P_{PRACH,b,f,c}(i) in an active UL BWP b of a carrier f of a serving cell c at a transmission occasion i based on a DL RS of the serving cell c according to Equation 4 below.

$${P}_{PRACH , b , f , c} ( i ) = min \{ {P}_{CMAX , f , c} ( i ) , {P}_{PRACH , t a r g e t , f , c} + {PL}_{b , f , c} \} [ dBm ] \qquad [ Equation 4 ]$$

P_{CMAX,f,c}(i) may be a UE configured maximum output power defined in the technical specifications for the carrier f of the serving cell c at the transmission occasion i. P_{PRACH,target,f,c} may be a PRACH target reception power (PREAMBLE_RECEIVED_TARGET_POWER) provided by higher layer signaling for the active UL BWP b of the carrier f of the serving cell c. PL_{b,f,c} may be a path loss for the active UL BWP b of the carrier f based on a DL RS associated with the PRACH transmission in the active DL BWP b of the serving cell c. PL_{b,f,c} may be calculated in dB units by the terminal based on referenceSignalPower. PL_{b,f,c} may be a higher layer filtered RSRP in dBm units. RSRP may be defined in the technical specifications. Higher layer filter configuration may be defined in the technical specifications. An active DL BWP may be an initial DL BWP. As defined in the technical specifications, for SS/PBCH block and CORESET multiplexing pattern 2 or 3, the terminal may determine PL_{b,f,c} based on an SS/PBCH block associated with the PRACH transmission.

In the above exemplary embodiment, the target power value (PREAMBLE_RECEIVED_TARGET_POWER) for the preamble may be determined based on higher layer operations as follows.

A MAC entity may perform the following for each random access preamble.
1> if PREAMBLE_TRANSMISSION_COUNTER is greater than 1;
1> no notification on power ramping counter suspension is received from lower layers; and
1> a selected SSB or CSI-RS has not changed from selection in the last random access preamble transmission:
   2> The MAC entity may increase PREAMBLE_POWER_RAMPING_COUNTER by 1.
1> The MAC entity may select a value of DELTA_PREAMBLE according to the technical specifications;
1> The MAC entity may set PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP.
1> The MAC entity, except for a CFRA preamble for a beam failure recovery request, may calculate an RA-RNTI associated with the PRACH occasion in which the random access preamble is transmitted; and
1> The MAC entity may instruct a physical layer to transmit a random access preamble using the selected PRACH occasion, the corresponding RA-RNTI (if available), PREAMBLE_INDEX, and PREAMBLE_RECEIVED_TARGET_POWER.

Based on the above exemplary embodiment, when the PRACH transmission fails, the terminal may increase (power ramping up) the PRACH transmission power each time the terminal performs PRACH retransmission. The base station may configure, to the terminal, a unit value for increasing the PRACH transmission power as a powerRampingStep parameter. The terminal may increase the PRACH transmission power by the value of powerRampingStep each time the terminal performs PRACH retransmission.

The terminal may perform the PRACH transmission to the base station by using one of an additional RO or a legacy RO. When the terminal fails PRACH transmission in a specific type of RO (i.e., when the number of PRACH transmissions reaches a maximum number of PRACH retransmissions), the terminal may continue PRACH transmission in another type of RO. The terminal may change a type of RO for PRACH transmission from additional RO to legacy RO. Alternatively, the terminal may change a type of RO for PRACH transmission from legacy RO to additional RO.

The terminal may select a legacy RO among legacy ROs or additional ROs and may perform PRACH transmission in the selected legacy RO. When the PRACH transmission fails, the terminal may perform PRACH retransmission in a legacy RO. When the number of PRACH transmissions in legacy ROs reaches a maximum number of PRACH retransmissions, the terminal may change a type of RO to additional RO and may perform PRACH transmission (e.g., PRACH retransmission) in an additional RO. In another example, the terminal may select an additional RO among legacy ROs or additional ROs and may perform PRACH transmission in the selected additional RO. When the PRACH transmission fails, the terminal may perform PRACH retransmission in an additional RO. When the number of PRACH transmissions in additional ROs reaches a maximum number of PRACH retransmissions, the terminal may change a type of RO to legacy RO and may perform PRACH transmission (e.g., PRACH retransmission) in a legacy RO.

When a type of RO is changed for PRACH retransmission (e.g., additional RO→legacy RO), the terminal may perform a power control operation for PRACH based on at least one of the following methods.

### [Method #1]

When RACH configuration method #1 is configured for the terminal, if a type of RO is changed from additional RO to legacy RO, the terminal may additionally increase the preamble power ramping counter by 1.
When RACH configuration method #2 is configured for the terminal, if a type of RO is changed from additional RO to legacy RO, the terminal may additionally increase the preamble power ramping counter by 1.

### [Method #2]

When RACH configuration method #1 is configured for the terminal, if a type of RO is changed from additional RO to legacy RO, the terminal may additionally increase the preamble power ramping counter by 1.
When RACH configuration method #2 is configured for the terminal, if a type of RO is changed from additional RO to legacy RO, the terminal may initialize the preamble power ramping counter to 1.

### [Method #3]

When RACH configuration method #1 is configured for the terminal, if a type of RO is changed from additional RO to legacy RO, the terminal may initialize the preamble power ramping counter to 1.
When RACH configuration method #2 is configured for the terminal, if a type of RO is changed from additional RO to legacy RO, the terminal may initialize the preamble power ramping counter to 1.

### [Method #4]

When RACH configuration method #1 is configured for the terminal, if a type of RO is changed from additional RO to legacy RO, the terminal may initialize the preamble power ramping counter to 1.
When RACH configuration method #2 is configured for the terminal, if a type of RO is changed from additional RO to legacy RO, the terminal may additionally increase the preamble power ramping counter by 1.

### [Method #5]

When RACH configuration method #1 is configured for the terminal, if a type of RO is changed from additional RO to legacy RO, the terminal may additionally increase the preamble power ramping counter by 1.
When RACH configuration method #2 is configured for the terminal, if a type of RO is changed from additional RO to legacy RO and different preamble formats are used between an additional RO and a legacy RO, the terminal may initialize the preamble power ramping counter to 1.

### [Method #6]

When RACH configuration method #1 is configured for the terminal, if a type of RO is changed from additional RO to legacy RO, the terminal may additionally increase the preamble power ramping counter by 1.
When RACH configuration method #2 is configured for the terminal, if a type of RO is changed from additional RO to legacy RO and a preamble format corresponding to a long sequence preamble is used in additional ROs and a preamble format corresponding to a short sequence preamble is used in legacy ROs, the terminal may initialize the preamble power ramping counter to 1.
When RACH configuration method #2 is configured for the terminal, if a type of RO is changed from additional RO to legacy RO, a preamble format corresponding to a short sequence preamble is used in additional ROs and a preamble format corresponding to a long sequence preamble is used in legacy ROs, the terminal may initialize the preamble power ramping counter to 1.

### [Method #7]

The base station may inform the terminal, through signaling (e.g., higher layer signaling), whether to increase the preamble power ramping counter or whether to initialize the power ramping counter when a type of RO is changed from additional RO to legacy RO. The terminal may perform power control of PRACH based on the information indicated by signaling of the base station. The terminal may additionally increase the preamble power ramping counter by 1 based on the information indicated by signaling of the base station. Alternatively, the terminal may initialize the preamble power ramping counter to 1 based on the information indicated by signaling of the base station.

When a type of RO is changed for PRACH retransmission (e.g., legacy RO→additional RO), the terminal may perform a power control operation for PRACH based on at least one of the following methods.

### [Method #1]

When RACH configuration method #1 is configured for the terminal, if a type of RO is changed from legacy RO to additional RO, the terminal may additionally increase the preamble power ramping counter by 1.
When RACH configuration method #2 is configured for the terminal, if a type of RO is changed from legacy RO to additional RO, the terminal may additionally increase the preamble power ramping counter by 1.

### [Method #2]

When RACH configuration method #1 is configured for the terminal, if a type of RO is changed from legacy RO to additional RO, the terminal may additionally increase the preamble power ramping counter by 1.
When RACH configuration method #2 is configured for the terminal, if a type of RO is changed from legacy RO to additional RO, the terminal may initialize the preamble power ramping counter to 1.

### [Method #3]

When RACH configuration method #1 is configured for the terminal, if a type of RO changes from legacy RO to additional RO, the terminal may initialize the preamble power ramping counter to 1.
When RACH configuration method #2 is configured for the terminal, if a type of RO changes from legacy RO to additional RO, the terminal may initialize the preamble power ramping counter to 1.

### [Method #4]

When RACH configuration method #1 is configured for the terminal, if a type of RO changes from legacy RO to additional RO, the terminal may initialize the preamble power ramping counter to 1.
When RACH configuration method #2 is configured for the terminal, if a type of RO changes from legacy RO to additional RO, the terminal may additionally increase the preamble power ramping counter by 1.

### [Method #5]

When RACH configuration method #1 is configured for the terminal, if a type of RO changes from legacy RO to additional RO, the terminal may additionally increase the preamble power ramping counter by 1.
When RACH configuration method #2 is configured for the terminal, if a type of RO changes from legacy RO to additional RO and different preamble formats are used between an additional RO and a legacy RO, the terminal may initialize the preamble power ramping counter to 1.

### [Method #6]

When RACH configuration method #1 is configured for the terminal, if a type of RO changes from legacy RO to additional RO, the terminal may additionally increase the preamble power ramping counter by 1.
When RACH configuration method #2 is configured for the terminal, if a type of RO changes from legacy RO to additional RO, a preamble format corresponding to a long sequence preamble is used in legacy ROs, and a preamble format corresponding to a short sequence preamble is used in additional ROs, the terminal may initialize the preamble power ramping counter to 1.
When RACH configuration method #2 is configured for the terminal, if a type of RO changes from legacy RO to additional RO, a preamble format corresponding to a short sequence preamble is used in legacy ROs, and a preamble format corresponding to a long sequence preamble is used in additional ROs, the terminal may initialize the preamble power ramping counter to 1.

### [Method #7]

When a type of RO changes from legacy RO to additional RO, the base station may notify the terminal, through signaling (e.g., higher layer signaling), of whether to increase the preamble power ramping counter or whether to initialize the preamble power ramping counter. The terminal may perform transmission power control of PRACH based on the information indicated by signaling of the base station. The terminal may additionally increase the preamble power ramping counter by 1 based on the information indicated by signaling of the base station. Alternatively, the terminal may initialize the preamble power ramping counter to 1 based on the information indicated by signaling of the base station.

A combination of PRACH power control method(s) in a case where a type of RO changes from additional RO to legacy RO and PRACH power control method(s) in a case where a type of RO changes from legacy RO to additional RO may be performed.

### Sixth Exemplary Embodiment: Power Control Method for Msg3 PUSCH

In the communication system (e.g., NR communication system), the terminal may determine a transmission power for Msg3 PUSCH as follows. Msg3 PUSCH may mean Msg3 transmitted through PUSCH.

When the terminal transmits PUSCH in an active UL BWP b of a carrier f of a serving cell c using a parameter set configuration with an index j and a PUSCH power control adjustment state with an index l, the terminal may determine a PUSCH transmission power P_{PUSCH,b,f,c,k}(i, j, q_{d}, l) in a PUSCH transmission occasion based on Equation 5 below.

$${P}_{PUSCH , b , f , c} ( i , j , {q}_{d} , l ) = min \{ \begin{matrix}{P}_{CMAX , f , c} ( i ) \\ {P}_{{O}_{PUSCH} , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} [ dBm ] \qquad [ Equation 5 ]$$

P_{CMAX,f,c}(i) may be a UE configured maximum output power defined in the technical specifications for the carrier f of the serving cell c in the PUSCH transmission occasion i.

P_{O_PUSCH,b,f,c}(j) may be a parameter configured as a sum of a component P_{O_NOMINAL,PUSCH,f,c}(j) and a component P_{O_UE_PUSCH,b,f,c}(j). j may be defined as j∈{0,1, . . . , J−1}.

P0-PUSCH-AlphaSet may not be provided to the terminal. Alternatively, as defined in the technical specifications, for PUSCH (re)transmission corresponding to an RAR UL grant, j=0, P_{O_UE_PUSCH,b,f,c}(0)=0, and P_{O_NOMINAL,PUSCH,f,c}(0)=P_{O_PRE}+Δ_{PREAMBLE,Msg3} may be defined. A parameter preambleReceivedTargetPower (for P_{O_PRE}) and Msg3-DeltaPreamble (for Δ_{PREAMBLE_Msg3}) may be provided by higher layers. If Msg3-DeltaPreamble is not provided, Δ_{PREAMBLE_Msg3}=0 may be defined for the carrier f of the serving cell c.

For a_{b,f,c}(J), if msg3−Alpha is provided for j=0, α_{b,f,c}(0) may be a value of Msg3−Alpha. Otherwise, α_{b,f,c}(0)=1.

$${M}_{RB , b , f , c}^{PUSCH} ( i )$$

may be bandwidth of a PUSCH resource allocation represented by the number of resource blocks for the PUSCH transmission occasion i in the active UL BWP b of the carrier f of the serving cell c. μ may be an SCS configuration defined in the technical specifications.

For

$${K}_{s} = 1.25 , {Δ}_{TF , b , f , c} ( i ) = 10 {log}_{10} ( ( {2}^{BPRE \cdot {K}_{s}} - 1 ) \cdot {β}_{offset}^{PUSCH} )$$

may be applied, and for Kₛ=0, Δ_{TF,b,f,c}(i)=0 may be applied. K_{S} may be provided by deltaMCS for each UL BWP b of each serving cell c and each carrier f. When a PUSCH transmission spans one or more layers, Δ_{TF,b,f,c}(i)=0 may be applied. Bits per resource element (BPRE) and

$${β}_{offset}^{PUSCH}$$

for the active UL BWP b of each carrier f and each serving cell c may be calculated as follows.

For PUSCH power control adjustment state f_{b,f,c}(i, l) in the active UL BWP b of the carrier f of the serving cell c in the PUSCH transmission occasion i, the terminal may receive a random access response message in response to PRACH transmission in the active UL BWP b of the carrier f of the serving cell c based on Equation 6 below.

$${f}_{b , f , c} ( 0 , l ) = Δ {P}_{rampup , b , f , c} + {δ}_{m s g 2 , b , f , c} , l = 0 \qquad [ Equation 6 ]$$

δ_{msg2,b,f,c} may be a transmit power control (TPC) command value indicated by a random access response grant of a random access response message corresponding to PRACH transmission in the active UL BWP b of the carrier f of the serving cell c.

$$Δ {P}_{rampup , b , f , c} = min [ \{ max ( 0 , {P}_{CMAX , f , c} - ( 10 {log}_{10} ( {2}^{μ} \cdot {M}_{RB , b , f , c}^{PUSCH} ( 0 ) ) + {P}_{O \_ PUSCH , b , f , c} ( 0 ) + {α}_{b , f , c} ( 0 ) \cdot {PL}_{c} + {Δ}_{TF , b , f , c} ( 0 ) + {δ}_{msg2 , b , f , c} ) ) \} , Δ {P}_{rampuprequested , b , f , c} ] \qquad [ Equation 7 ]$$

Equation 7 and ΔP_{rampup_requested,b,f,c} may be provided by higher layers and may correspond to a total power ramp-up requested by higher layers from the first random access preamble to the last random access preamble for the carrier f in the serving cell c.

$${M}_{RB , b , f , c}^{PUSCH} ( 0 )$$

may be a bandwidth of a PUSCH resource allocation represented by the number of resource blocks for the first PUSCH transmission in the active UL BWP b of the carrier f of the serving cell c. Δ_{TF,b,f,c}(0) may be a power adjustment of the first PUSCH transmission in the active UL BWP b of the carrier f of the serving cell c.

In RACH configuration method #1, in order to determine a target reception power value P_O_NOMINAL_PUSCH for Msg3 PUSCH, the terminal may determine P_{O_PRE} by considering a target reception power value for a different preamble according to a type (e.g., SBFD symbol or N-SBFD symbol) of symbols in which Msg3 PUSCH is transmitted. For example, when a target reception power value set for PRACH transmitted in SBFD symbols is P_sbfd and a target reception power value set for PRACH transmitted in N-SBFD symbol is P_nsbfd, the terminal may apply P_sbfd as P_{O_PRE} for the target reception power value for Msg3 PUSCH transmitted in SBFD symbols, and the terminal may apply P_nsbfd as P_{O_PRE} for the target reception power value for Msg3 PUSCH transmitted in N-SBFD symbols. The terminal may determine the transmission power for Msg3 PUSCH based on the above exemplary embodiment.

In RACH configuration method #2, in order to determine a target reception power value P_O_NOMINAL_PUSCH for Msg3 PUSCH, the terminal may determine P_{O_PRE} by considering a target reception power value for a different preamble according to a type (e.g., SBFD symbol or N-SBFD symbol) of symbols in which Msg3 PUSCH is transmitted. For example, when a target reception power value set for PRACH transmitted in SBFD symbols is P_sbfd and a target reception power value set for PRACH transmitted in N-SBFD symbols is P_nsbfd, the terminal may apply P_sbfd as P_{O_PRE} for the target reception power value for Msg3 PUSCH transmitted in SBFD symbols, and the terminal may apply P_nsbfd as P_{O_PRE} for the target reception power value for Msg3 PUSCH transmitted in N-SBFD symbols. The terminal may determine the transmission power for Msg3 PUSCH based on the above exemplary embodiment.

In the random access procedure of the SBFD terminal, an RO type of the most recent PRACH transmission and a symbol type of Msg3 PUSCH transmission may be determined independently from each other. In other words, regardless of whether the RO type of PRACH transmission is legacy RO or additional RO, the base station may schedule Msg3 PUSCH transmission in either SBFD symbols or N-SBFD symbols.

The terminal may consider an accumulated total power ramp-up value from the first random access preamble transmission to the last random access preamble transmission as in Equations 5, 6, and 7 for power control for Msg3 PUSCH.

When an RO type of PRACH transmission and a symbol type of Msg3 PUSCH transmission are different from each other (e.g., when the RO type of PRACH transmission is legacy RO and the symbol type of Msg3 PUSCH transmission is SBFD symbol, or when the RO type of PRACH transmission is additional RO and a symbol type of Msg3 PUSCH transmission is N-SBFD symbol), whether the terminal maintains an accumulated power ramp-up value until the most recent transmission may be further considered. When an RO type is changed in a PRACH retransmission procedure (e.g., when the RO type is changed from additional RO to legacy RO or when the RO type is changed from legacy RO to additional RO), whether the terminal reflects accumulated power ramp-up values accumulated in different RO types as they are in power control for Msg3 PUSCH may be determined. The above exemplary embodiment may affect a power control method of the terminal, whether buffering is present, and a size of uplink interference.

### (Scenario #1: The Most Recent PRACH Transmission Succeeds in a Legacy RO)

When an RO type in which the most recent PRACH transmission of the terminal (e.g., SBFD terminal) is performed is legacy RO, the base station may determine the terminal as a legacy terminal rather than an SBFD terminal. Accordingly, the base station may schedule a symbol type for Msg3 PUSCH transmission as N-SBFD symbol. When the SBFD terminal attempts PRACH transmission using a legacy RO from the beginning, it may be preferable that the SBFD terminal performs power control for Msg3 PUSCH in the same manner as a legacy terminal depending on a case. When the SBFD terminal initially attempts PRACH transmission in an additional RO and subsequently performs PRACH transmission in a legacy RO and succeeds in PRACH transmission, it may be preferable that the SBFD terminal performs power control for Msg3 PUSCH in a manner different from that of a legacy terminal. Specifically, the following operations may be considered.
Case #1) Case in which the SBFD terminal attempts PRACH transmission only in legacy RO(s) and the PRACH transmission succeeds
   The SBFD terminal may perform power control in the same manner as a legacy terminal. For example, the SBFD terminal may determine P_{O_PRE} by applying preambleReceivedTargetPower configured for legacy ROs. The SBFD terminal may determine ΔP_{rampup_requested,b,f,c} by applying an accumulated total power ramp-up value until the most recent transmission.
Case #2) Case in which the SBFD terminal attempts PRACH transmission in an additional RO, changes an RO type from additional RO to legacy RO, and succeeds in PRACH transmission in a legacy RO
   Case #2-1) When the RO type is changed from additional RO to legacy RO in the PRACH retransmission procedure, the terminal may initialize the power ramping counter for PRACH to 1. Thereafter, the terminal may succeed in PRACH transmission in a legacy RO, may receive an RAR message from the base station, and may identify scheduling information of Msg3 PUSCH transmission included in the RAR message. The terminal may determine ΔP_{rampup_requested,b,f,c} for Msg3 PUSCH transmission by applying preambleReceivedTargetPower configured for legacy ROs. The terminal may determine ΔP_{rampup_requested,b,f,c} by applying an accumulated total power ramp-up value from the first PRACH transmission to the last PRACH transmission in legacy ROs.
   Case #2-2) When the RO type is changed from additional RO to legacy RO in a PRACH retransmission procedure, the terminal may continuously increase a power ramping counter for PRACH. Thereafter, the terminal may succeed in PRACH transmission in the legacy RO, may receive an RAR message from the base station, and may identify scheduling information of Msg3 PUSCH transmission included in the RAR message. The terminal may determine ΔP_{rampup_requested,b,f,c} for Msg3 PUSCH transmission by applying preambleReceivedTargetPower configured for legacy ROs. The terminal may determine ΔP_{rampup_requested,b,f,c} based on at least one of the following methods.
      Method #1) The terminal may apply an accumulated total power ramp-up value from the first PRACH transmission to the last PRACH transmission. In other words, the terminal may determine ΔP_{rampup_requested,b,f,c} by applying an accumulated total power ramp-up value from the first PRACH transmission in an additional RO to the last PRACH transmission in a legacy RO.
      Method #2) The terminal may apply an accumulated total power ramp-up value from the first PRACH transmission to the last PRACH transmission in legacy ROs. In other words, the terminal may ignore a power ramp-up value accumulated in additional ROs among an accumulated total power ramp-up value from the first PRACH transmission in an additional RO to the last PRACH transmission in a legacy RO, and may perform power control for Msg3 PUSCH by considering the power ramp-up value accumulated in legacy ROs.

### (Scenario #2: The Most Recent PRACH Transmission Succeeds in an Additional RO)

When an RO type in which the most recent PRACH transmission of the terminal (e.g., SBFD terminal) is performed is additional RO, the base station may determine the terminal as an SBFD terminal. Accordingly, the base station may schedule a symbol type for Msg3 PUSCH transmission as SBFD symbol or N-SBFD symbol. In this case, the SBFD terminal may comprehensively consider an RO type (e.g., additional RO or legacy RO) used for PRACH transmission and/or a symbol type (e.g., SBFD symbol or N-SBFD symbol) for Msg3 PUSCH transmission in power control operation for Msg3 PUSCH. A power control operation for Msg3 PUSCH when the SBFD terminal attempts PRACH transmission in an additional RO from the beginning and a power control operation for Msg3 PUSCH when the SBFD terminal initially attempts PRACH transmission in a legacy RO and subsequently performs PRACH transmission in an additional RO may be performed differently from each other. Specifically, the following operations may be considered.
Case #1) Case in which the SBFD terminal attempts PRACH transmission only in additional ROs and the PRACH transmission succeeds
   Case #1-1) When a symbol type for Msg3 PUSCH transmission is scheduled as SBFD symbol, the SBFD terminal may perform power control for Msg3 PUSCH based on parameters configured for additional ROs. For example, the terminal may determine P_{O_PRE} by applying preambleReceivedTargetPower configured for additional ROs. The terminal may determine ΔP_{rampup_requested,b,f,c} by applying an accumulated total power ramp-up value from the first PRACH transmission to the last PRACH transmission.
   Case #1-2) Case in which a symbol type for Msg3 PUSCH transmission is scheduled as N-SBFD symbol
      The SBFD terminal may perform power control for Msg3 PUSCH based on parameters configured for legacy ROs. For example, the terminal may determine P_{O_PRE} by applying preambleReceivedTargetPower configured for legacy ROs. The terminal may determine ΔP_{rampup_requested,b,f,c} based on at least one of the following methods.
         Method #1) The terminal may apply an accumulated total power ramp-up value from the first PRACH transmission to the last PRACH transmission to determine ΔP_{rampup_requested,b,f,c}.
         Method #2) The terminal may regard ΔP_{rampup_requested,b,f,c} as 0. Since an RO type used for PRACH transmission corresponds to SBFD symbol and a symbol type used for Msg3 PUSCH transmission corresponds to N-SBFD symbol, the terminal may ignore an accumulated power ramp-up value for PRACH transmission in the previous additional ROs.
         Method #3) The terminal may determine ΔP_{rampup_requested,b,f,c} by applying an additional power offset value Δ_{offset} to an accumulated total power ramp-up value from the first PRACH transmission to the last PRACH transmission. The additional power offset value Δ_{offset} may be preconfigured for the terminal through higher layer signaling of the base station. Since an RO type used for PRACH transmission corresponds to SBFD symbol and a symbol type used for Msg3 PUSCH transmission corresponds to N-SBFD symbol, if an accumulated power ramp-up value for PRACH transmission in the previous additional ROs is used as it is for transmission power control of Msg3 PUSCH in N-SBFD symbols, an unexpected uplink interference problem may occur. Accordingly, the terminal may perform transmission power control of Msg3 PUSCH by considering the additional power offset value Δ_{offset}.
Case #2) Case in which the SBFD terminal attempts PRACH transmission in a legacy RO, changes an RO type from legacy RO to additional RO, attempts PRACH transmission in an additional RO, and succeeds in PRACH transmission
   Case #2-1) When an RO type is changed from legacy RO to additional RO in a PRACH retransmission procedure, the terminal may initialize the power ramping counter for PRACH to 1. The terminal may succeed in PRACH transmission in an additional RO, may receive an RAR message from the base station, and may identify scheduling information of Msg3 PUSCH transmission included in the RAR message.
      Case #2-1-1) Case in which a symbol type for Msg3 PUSCH transmission is scheduled as SBFD symbol
         The SBFD terminal may perform power control for Msg3 PUSCH based on parameters configured for additional ROs. For example, the terminal may determine P_{O_PRE} by applying preambleReceivedTargetPower configured for additional ROs. The terminal may determine ΔP_{rampup_requested,b,f,c} by applying an accumulated total power ramp-up value from the first PRACH transmission to the last PRACH transmission in additional ROs.
      Case #2-1-2) Case in which a symbol type for Msg3 PUSCH transmission is scheduled as N-SBFD symbol
         The SBFD terminal may perform power control for Msg3 PUSCH based on parameters configured for legacy ROs. For example, the terminal may determine P_{O_PRE} by applying preambleReceivedTargetPower configured for legacy ROs. The terminal may determine ΔP_{rampup_requested,b,f,c} based on at least one of the following methods.
         Method #1) The terminal may determine ΔP_{rampup_requested,b,f,c} by applying an accumulated total power ramp-up value from the first PRACH transmission to the last PRACH transmission in additional ROs.
         Method #2) The terminal may regard ΔP_{rampup_requested,b,f,c} as 0. Since an RO type used for PRACH transmission corresponds to SBFD symbol and a symbol type used for Msg3 PUSCH transmission corresponds to N-SBFD symbol, the terminal may ignore an accumulated power ramp-up value for PRACH transmission in the previous additional ROs.
         Method #3) The terminal may determine ΔP_{rampup_requested,b,f,c} by applying an additional power offset value Δ_{offset} to an accumulated total power ramp-up value from the first PRACH transmission to the last PRACH transmission in additional ROs. The additional power offset value Δ_{offset} may be preconfigured for the terminal through higher layer signaling of the base station. Since an RO type used for PRACH transmission corresponds to SBFD symbol and a symbol type used for Msg3 PUSCH transmission corresponds to N-SBFD symbol, if an accumulated power ramp-up value for PRACH transmission in the previous additional ROs is used as it is for transmission power control of Msg3 PUSCH in N-SBFD symbols, an unexpected uplink interference problem may occur. Accordingly, the terminal may perform power control by considering the additional power offset value Δ_{offset}.
   Case #2-2) When an RO type is changed from legacy RO to additional RO, in a PRACH retransmission procedure, the terminal may continuously increase a power ramping counter for PRACH. The terminal may succeed in PRACH transmission in an additional RO, may receive an RAR message from the base station, and may identify scheduling information for Msg3 PUSCH transmission included in the RAR message.
      Case #2-2-1) Case in which a symbol type for Msg3 PUSCH transmission is scheduled as SBFD symbol
         The SBFD terminal may perform power control for Msg3 PUSCH based on parameters configured for additional ROs. For example, the terminal may determine P_{O_PRE} by applying preambleReceivedTargetPower configured for additional ROs. The terminal may determine ΔP_{rampup_requested,b,f,c} based on at least one of the following methods.
         Method #1) The terminal may apply an accumulated total power ramp-up value from the first PRACH transmission to the last PRACH transmission. In other words, the terminal may determine ΔP_{rampup_requested,b,f,c} by applying an accumulated total power ramp-up value from the first PRACH transmission in a legacy RO to the last PRACH transmission in an additional RO.
         Method #2) The terminal may apply an accumulated total power ramp-up value from the first PRACH transmission to the last PRACH transmission in additional ROs among PRACH transmissions. In other words, among an accumulated total power ramp-up value from the first PRACH transmission in a legacy RO to the last PRACH transmission in an additional RO, the terminal may ignore a power ramp-up value accumulated in legacy ROs and may perform power control for Msg3 PUSCH by considering a power ramp-up value accumulated in additional ROs.
      Case #2-2-2) Case in which a symbol type for Msg3 PUSCH transmission is scheduled as N-SBFD symbol
         The SBFD terminal may perform power control for Msg3 PUSCH based on parameters configured for legacy ROs. For example, the terminal may determine P_{O_PRE} by applying preambleReceivedTargetPower configured for legacy ROs. The terminal may determine ΔP_{rampup_requested,b,f,c} based on at least one of the following methods.
         Q Method #1) The terminal may apply an accumulated total power ramp-up value from the first PRACH transmission to the last PRACH transmission. In other words, the terminal may determine ΔP_{rampup_requested,b,f,c} by applying an accumulated total power ramp-up value from the first PRACH transmission in a legacy RO to the last PRACH transmission in an additional RO.
         Method #2) The terminal may apply an accumulated total power ramp-up value from the first PRACH transmission to the last PRACH transmission in legacy ROs among PRACH transmissions. In other words, among an accumulated total power ramp-up value from the first PRACH transmission in a legacy RO to the last PRACH transmission in an additional RO, the terminal may consider only a power ramp-up value accumulated in legacy ROs and may perform power control for Msg3 PUSCH while ignoring a power ramp-up value accumulated in additional ROs.
         Method #3) The terminal may regard ΔP_{rampup_requested,b,f,c} as 0. Since an RO type used for PRACH transmission corresponds to SBFD symbol and a symbol type used for Msg3 PUSCH transmission corresponds to N-SBFD symbol, the terminal may ignore an accumulated power ramp-up value from the first PRACH transmission to the last PRACH transmission.
         Method #4) The terminal may determine ΔP_{rampup_requested,b,f,c} by applying an additional power offset value Δ_{offset} to an accumulated total power ramp-up value from the first PRACH transmission to the last PRACH transmission. The additional power offset value Δ_{offset} may be preconfigured for the terminal through higher layer signaling of the base station. Since an RO type used for PRACH transmission corresponds to SBFD symbol and a symbol type used for Msg3 PUSCH transmission corresponds to N-SBFD symbol, if an accumulated power ramp-up value for PRACH transmission in the previous legacy ROs and additional ROs is used as it is for transmission power control of Msg3 PUSCH in N-SBFD symbols, an unexpected uplink interference problem may occur. Accordingly, the terminal may perform power control by considering the additional power offset value Δ_{offset}.

Combinations of the above exemplary embodiments may be performed. Combinations of methods included in the respective exemplary embodiments may be performed. The base station may transmit, to the terminal, signaling (e.g., SI signaling, RRC signaling, MAC CE signaling, DCI signaling) indicating execution of one exemplary embodiment, a combination of exemplary embodiments, one method, or a combination of methods. The terminal may perform one exemplary embodiment, a combination of exemplary embodiments, one method, or a combination of methods based on the signaling of the base station.

Criteria, priorities, and the like for selecting one exemplary embodiment, a combination of exemplary embodiments, one method, or a combination of methods by the communication node (e.g., the base station and/or the terminal) may be predefined in the technical specifications. The base station may transmit, to the terminal, signaling (e.g., SI signaling, RRC signaling, MAC CE signaling, DCI signaling) indicating criteria and/or priorities for selecting one exemplary embodiment, a combination of exemplary embodiments, one method, or a combination of methods. The terminal may select one exemplary embodiment, a combination of exemplary embodiments, one method, or a combination of methods based on criteria and/or priorities indicated by signaling of the base station.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, configuration information for a legacy random access channel (RACH) occasion (RO) and an additional RO;
determining validity of an RO based on the configuration information; and
performing a physical random access channel (PRACH) transmission in a valid RO,
wherein the legacy RO is configured in a non-subband full-duplex (N-SBFD) resource, and the additional RO is configured in an SBFD resource.

2. The method of claim 1, wherein the configuration information is applied to both the legacy RO and the additional RO, or the configuration information includes legacy RACH configuration information for configuring the legacy RO and additional RACH configuration information for configuring the additional RO.

3. The method of claim 1, wherein the determining of validity of an RO based on the configuration information comprises:
determining a starting physical resource block (PRB) of the additional ROs by applying an offset included in the configuration information to a PRB having a lowest index within an uplink (UL) subband; and
determining the additional RO as an invalid RO based on at least one PRB of the additional RO being located outside the UL subband,
wherein the PRACH transmission is not performed in the invalid RO.

4. The method of claim 1, wherein indexing for the additional ROs is performed independently of indexing for the legacy ROs.

5. The method of claim 1, further comprising: receiving, from the base station, a physical downlink control channel (PDCCH) order including information indicating a UL cell or a supplementary uplink (SUL) cell in which the PRACH transmission is to be performed.

6. The method of claim 5, wherein, based on the PDCCH order indicating that the PRACH transmission is to be performed in the SUL cell, the PRACH transmission is performed in the legacy RO.

7. The method of claim 5, wherein, based on the PDCCH order indicating that the PRACH transmission is to be performed in the UL cell, the PRACH transmission is performed in an RO indicated by an RO indicator included in the PDCCH order among the legacy RO and the additional RO.

8. The method of claim 1, further comprising:
receiving, from the base station, a random access response (RAR) message in response to the PRACH transmission;
determining a transmission power of a message 3 (Msg3) based on a power of the PRACH transmission; and
transmitting the Msg3 to the base station using the determined transmission power.

9. The method of claim 8, wherein the transmission power of the Msg3 is determined based on an accumulated power ramp-up value from an initial PRACH transmission in the additional RO to a last PRACH transmission in the legacy RO.

10. The method of claim 8, wherein the transmission power of the Msg3 is determined based on an accumulated power ramp-up value from an initial PRACH transmission in the legacy RO to a last PRACH transmission in the additional RO.

11. A terminal comprising at least one processor, wherein the at least one processor causes the terminal to perform:
receiving, from a base station, configuration information for a legacy random access channel (RACH) occasion (RO) and an additional RO;
determining validity of an RO based on the configuration information; and
performing a physical random access channel (PRACH) transmission in a valid RO,
wherein the legacy RO is configured in a non-subband full-duplex (N-SBFD) resource, and the additional RO is configured in an SBFD resource.

12. The terminal of claim 11, wherein the configuration information is applied to both the legacy RO and the additional RO, or the configuration information includes legacy RACH configuration information for configuring the legacy RO and additional RACH configuration information for configuring the additional RO.

13. The terminal of claim 11, wherein in the determining of validity of an RO based on the configuration information, the at least one processor causes the terminal to perform:
determining a starting physical resource block (PRB) of the additional ROs by applying an offset included in the configuration information to a PRB having a lowest index within an uplink (UL) subband; and
determining the additional RO as an invalid RO based on at least one PRB of the additional RO being located outside the UL subband,
wherein the PRACH transmission is not performed in the invalid RO.

14. The terminal of claim 11, wherein indexing for the additional ROs is performed independently of indexing for the legacy ROs.

15. The terminal of claim 11, wherein the at least one processor further causes the terminal to perform: receiving, from the base station, a physical downlink control channel (PDCCH) order including information indicating a UL cell or a supplementary uplink (SUL) cell in which the PRACH transmission is to be performed.

16. The terminal of claim 15, wherein, based on the PDCCH order indicating that the PRACH transmission is to be performed in the SUL cell, the PRACH transmission is performed in the legacy RO.

17. The terminal of claim 15, wherein, based on the PDCCH order indicating that the PRACH transmission is to be performed in the UL cell, the PRACH transmission is performed in an RO indicated by an RO indicator included in the PDCCH order among the legacy RO and the additional RO.

18. The terminal of claim 11, wherein the at least one processor further causes the terminal to perform:
receiving, from the base station, a random access response (RAR) message in response to the PRACH transmission;
determining a transmission power of a message 3 (Msg3) based on a power of the PRACH transmission; and
transmitting the Msg3 to the base station using the determined transmission power.

19. The terminal of claim 18, wherein the transmission power of the Msg3 is determined based on an accumulated power ramp-up value from an initial PRACH transmission in the additional RO to a last PRACH transmission in the legacy RO.

20. The terminal of claim 18, wherein the transmission power of the Msg3 is determined based on an accumulated power ramp-up value from an initial PRACH transmission in the legacy RO to a last PRACH transmission in the additional RO.
